(19) United States
(12) Patent Application Publication
(10) Pub. No.: US 2004/0003935 A1
(43) Pub. Date: Jan. 8, 2004

(54) Cableway

(75) Inventors: Andre Colmart, Noeux Les Mines (FR); Thierry Loyer, Cauchy La Tour (FR); Richard Tama, Burbure (FR)

Correspondence Address: Edward J. Kondracki, Miles & Stockbridge, P.C., 1751 Pinnacle Drive, Suite 500, McLean, VA, 22102-3833, US

(73) Assignee: TOLMEGA, Reims (FR)

(21) Appl. No.: 10/434,466

(22) Filed: May 9, 2003

(30) Foreign Application Priority Data
May 10, 2002 (EP) 02370019.8
May 11, 2001 (FR) 01/06262

(51) Int. Cl. H02G 3/04

(52) U.S. Cl. 174/48

(57) ABSTRACT

A cableway, comprising at least two segments provided with means suitable and designed for enabling relative movement of the two segments between a compact, first position for transport or storage and a deployed, second position for use, in which the end portions of the segments are substantially in longitudinal alignment, means being provided to lock the segments in said second position.

The invention relates to the technical field of cableways.

### BACKGROUND OF THE INVENTION

Cableways are gutter-shaped structures serving to support, guide, and protect cables such as, for example: electrical cables, telephone cables, optical fiber cables, computer network cables, and pipework.

Cableways can be made as wire baskets or out of optionally-perforated sheets, and terms such as “cableways”, “basket cableways”, “perforated cableways”, and “solid-base cableways” are used herein with reference in particular to the international standard published in September 2001 under the No. CEI 61537.

The term “basket cableways” is-used herein to designate cableways made by assembling together two series of wires, namely a first series of wires commonly referred to as “warp” wires which run longitudinally in a manner that is typically rectilinear or quasi-rectilinear over their entire length; and a second series of wires, commonly referred to as “weft” wires that extend transversely at intervals across the warp wires.

As a general rule, the warp and weft wires are made of metal alloy and they are conventionally assembled together by welding. The weft wires are typically U-shaped so that a basket cableway comprises a bottom panel and two side panels, commonly referred to as flanges. The term “wire” is used herein both to cover solid section members of substantially oval or circular cross-section and section members of cross-section that is square or rectangular. In particular, the weft wires may be constituted by narrow strips of rectangular cross-section.

The wires may be identical in section or otherwise, with the longitudinal wires of the bottom panel other than those closest to the side flanges being of smaller section, for example.

In order to withstand corrosion, the wire basket can be coated or zinc-plated or hot-galvanized. The wires are conventionally welded together while flat, with the basket subsequently being deformed by folding or bending, after welding, so as to take up a gutter shape.

Examples of basket cableways of the type descried above are to be found in the following documents: French patent applications published under the following numbers: 2 017 070, 2 376 539, 2 576 158, 2 599 906, 2 613 146, 2 617 341, 2 628 904, 2 634 600, 2 645 359, 2 652 206, 2 652 142, 2 669 708, 2 686 393, 2 687 207, 2 691 590, 2 697 313, 2 697 690, 2 698 416, 2 706 973, 2 716 242, 2 716 768, 2 723 270, 2 725 772, 2 725 846, 2 727 186, 2 728 649, 2 734 503, 2 737 355, 2 750 754, 2 766 897; European patent applications published under the numbers 0 191 667, 0 229 544, 0 275 185, 0 352 191, 0 355 081, 0 390 668, 0 418 167, 0 553 039, 0 556 137, 0 718 944, 0 818 862, 0 905 843; international patent applications published under the numbers 96/08063, 99/06746; and German patent applications published under the numbers 2 036 325, 4 037 412, 4 336 168.

The term “sheet cableways” is used herein to designate cableways formed by assembling together section members, generally made of metal, comprising at least a wall forming a bottom together with two flanges, such section members typically presenting U-shaped or C-shaped channel sections. The walls of sheet cableways can be solid or perforated, and they are sometimes configured at their free edges so as to be capable of receiving a cover, e.g. by snap-fastening.

In order to withstand corrosion, the sheet metal is conventionally subjected to surface treatment such as being painted, zinc-plated, or hot-galvanized.

Where appropriate, if the atmosphere is very aggressive, stainless steel is used for the sheet metal. Cableways can also be made of composite material, for example reinforced polyester, and obtained in particular by pultrusion.

Examples of sheet cableways of the type mentioned above are to be found in the following documents: French patent applications published under the numbers 1 471 497, 2 290 063, 2 306 552, 2 313 786, 2 365 902, 2 385 539, 2 395 449, 2 406 327, 2 435 844, 2 478 389, 2 481 015, 2 536 219, 2 610 145, 2 610 769, 2 615 587, 2 683 403, 2 686 142, 2 689 605, 2 691 227, 2 691 228, 2 712 831, 2 734 956, 2 749 912, 2 749 913, 2 749 914, 2 769 761, 2 481 015; European patent applications published under the numbers 0 054 456, 0 113 981, 0 208 924, 0 278 923, 0 292 389, 0 315 531, 0 348 285, 0 403 440, 0 518 404, 0 570 272, 0 657 672, 0 695 009, 0 813 012; and the international patent application published under the No. 93/23694.

For many years, and without there being any applicable international or European regulations, the longitudinal size of cableway segments, whether of the basket or of the sheet type, has generally been three meters, as mentioned on page 2, lines 12 and 13 of document FR-A-2 737 355.

Using such segments, networks of cableways are built up as described.

For this purpose, cableway segments are positioned end to end and the segments are held together by flat plates known as “fishplates”, possibly including articulated joints, or by angle pieces.

Segments are also fixed at intervals to brackets or to hangers, or else they are suspended, with the distance between supports being typically about one-and-a-half meters.

Over many years, cableway manufacturers have developed a wide variety of technical solutions seeking to make it easier to interconnect cableway segments, both in terms of the number of tools and parts required and in terms of the time needed to mount fishplates onto segments.

The diversity of those technical solutions clearly illustrates the importance of such fishplates to manufacturers. Four broad types of fishplate mounting can be distinguished:

bolting, as described in documents EP-A-0 298 825, EP-A-0 399 790, EP-A-0 617 493;

welding, as described in document EP-A-0 571 307;

folding back tabs previously inserted in perforations in sheet cableways, as described in documents FR-A-1 584 328, EP-A-0 461 974; and

force-fitting or snap-fastening, as described in documents DE-U-89/01613, FR-A-2 686 141, FR-A-2 606 843, FR-A-2 303 843, FR-A-2 208 219, U.S. Pat. No. 5,384,937, EP-A-0 083 809, EP-A-0 933 850, U.S. Pat. No. 6,193,434.

Assembly fishplates are also known that are slidably mounted: documents GB-A-2 237 454, FR-A-2 588 426, EP-A-0 822 364, EP-A-1 193 821.

Transporting and storing cableways gives rise to high levels of cost.

The Applicant has found that the three-meter length of cableway segments to which fitters have become accustomed gives rise to high costs and/or considerable time in transport, because of the size required of the vehicles used for transportation purposes.

The Applicants have been searching for means enabling such transport costs to be reduced.

Document EP-A-0 074 698 proposes stacking cable ladders. Cable ladders conventionally comprise two substantially parallel longitudinally-extending stringer members having rungs (sometimes referred to as “crossmembers” or “cross-bars”) extending between them, with the cables resting thereon either directly or via intermediate supports.

Stacking cable ladders is also proposed in document GB-A-2 105 920.

The Applicant has found that stacking cableway segments leads to numerous practical problems:

the need to change the conventional channel-section shape of segments so as to enable them to be stacked; and

the difficulty in unstacking segments because of friction or jamming between the segments, after they have been stacked for some length of time and due to creep under load.

Documents EP-A-0 818 862 and U.S. Pat. No. 5,927,658 describe stackable basket cableway segments with cross-sections that flare in stages, the cross wires having two bends in the flanges of the segments so as to make them stackable.

The specific shape of stackable cableway segments as described in documents EP-A-0 818 862 and U.S. Pat. No. 5,927,658 does not make them easy to inter-assemble with conventional segments.

The practical difficulties associated with stacking and unstacking segments have meant that although stacking is proposed in recurrent manner (cf. documents CH-A-634178 of 1978, EP-A-0 298 825 of 1988, and EP-A-0 818 862 of 1997) that technical solution does not, in fact, provide an answer to the problem posed by the space occupied by segments, whether during transport or in storage.

Another solution proposed in the prior art for reducing dead volumes during storage and transport consists in providing an articulated joint in one of the flanges of basket cableways so as to enable that cableway to occupy a folded waiting position during storage or transport (cf. document EP-A-0 191 667).

Proposals have also been made for basket cableways made up of separable longitudinal elements that can be united with one another by means of engagement devices (cf. documents FR-A-2 599 906 and FR-A-2 613 146).

Such designs present numerous drawbacks. In particular, cableway segments provided with means for assembling longitudinal sub-segments present little strength, unless the assembly means are further complicated.

### OBJECTS AND SUMMARY OF THE INVENTION

The invention seeks to provide means for reducing dead volumes and/or lengths during storage or transport of cableway segments, such means avoiding the drawbacks of those known in the prior art and making it possible, in particular, to maintain a cross-section for the segments that is compatible with the cross-sections of conventional cableways, in particular with respect to interconnection by fishplates.

The invention also seeks to provide cableway segments of useful length corresponding to the habits of fitters and/or enabling fitters to improve their productivity.

The invention seeks in particular to provide fitters with cableway segments of length greater than the conventional length, thus reducing the number of interconnection operations.

The invention also seeks to provide basket or sheet cableway segments of dimensions that are optimized relative to the transport means selected.

For these purposes, the invention provides, in a first aspect, a cableway comprising at least two segments provided with means suitable and designed for enabling relative movement of the two segments between a compact, first position for transport or storage and a deployed, second position for use, in which the end portions of the segments are substantially in longitudinal alignment, means being provided to lock the segments in said second position.

The means suitable and designed for enabling relative movement of the two segments between their first and second relative positions are articulated joint means or sliding means, the segments may be joined so as to be capable of turning through substantially 180°, and sliding may advantageously be combined with an articulated joint.

In a first general type of embodiment, the joint means define an axis of articulation substantially parallel to a direction transverse to the bottom walls of the segments.

In a second general type of embodiment, the joint means define an axis of articulation substantially parallel to a direction that is transverse to one of the flanges of each of the segments. It should be understood that both the first and the second types of embodiment can be used together for building up a given cableway network.

In a first series of embodiments, the two segments are joined by articulated joint means comprising a hinge.

In various particular embodiments, the hinge presents the following characteristics, possibly in combination:

it comprises respective leaves fitted to or integral with each of the two segments, the fitted leaf carrying knuckles complementary to knuckles carried by the other segment;

it comprises two fitted or integral leaves, each segment supporting one of the leaves, a pin passing through the knuckles of the leaves, the pin advantageously being removable, in particular when the segments are stackable after removing the pin; and

it is of the type selected from the group constituted by: hinges having blank leaves for drilling and countersinking from either face, hinges having leaves in the form of sheets folded in half, hinges having leaves that are offset when parallel, hinges with leaves tapering away from their hinge pins, hinges having pairs of parallel pins interconnected by links, spring hinges, piano hinges.

In other particular embodiments, each of the two segments carries, on at least one of its transverse edges, knuckle-forming projections formed integrally therewith or fitted thereto. For example, a first segment carries, on one of its transverse free edges, at least two knuckle-forming projections, a second segment for being joined to the first segment carrying on one of its transverse free edges at least two through holes for passing said projections. The through holes in the bottom wall of the second segment are set back longitudinally from the transverse plane tangential to the free end edges of the flanges of said second segment, the knuckle-forming projections disposed on the bottom wall of the first segment projecting beyond the transverse plane tangential to the free end edges of the flanges of said first segment.

In a second series of embodiments, each of the two segments comprises two flanges projecting from the side edges of a bottom wall, the articulated joints between the two segments enabling them to move between their first and second relative positions being provided by joint means placed on each of the flanges of said segments.

In a first series of variants, the joint means comprise link pieces mounted or shaped on the facing inner faces of the flanges of the segments.

In various particular embodiments, the inner link pieces present the following characteristics, possibly in combination:

they present at least one slot through which there passes a pin carried by a flange of a first segment, each link piece further comprising at least one stud that engages in a recess carried by a flange of the second segment, the engagement of the stud in the recess during pivoting of one segment relative to the other serving to lock the end portions of the two segments in longitudinal alignment;

they are substantially plane and in the form of half-disks or half-rings, the end portions of the segments that face each other being provided with longitudinal slots for passing link pieces; and

the studs of the link pieces are the result of stamping, the recesses in which said studs are received being optionally-through holes.

In a second series of variants, the joint means comprise two link pieces mounted an the outer faces of the flanges of the segments.

In various particular embodiments, each link piece includes an elongate slot in which two pins projecting outwards from the segment flanges are slidably received, said slot being provided with notches that are spaced apart by substantially the distance between the pins as measured when the two segments are in the longitudinally-aligned position.

In a third series of embodiments, the two segments are joined by means of a transverse line of weakness comprising perforations through the bottom walls or one of the flanges of the segments, and/or reduced thickness in said bottom walls or said flanges.

In a fourth series of embodiments, the flanges of a first segment are provided with longitudinal projections supporting a transverse pin common to the flanges of the second segment. At least one of the longitudinal projections is provided with portions in relief such as stampings that are received in locking setbacks disposed in the second segment, when the two segment are in longitudinal alignment.

In a fifth series of embodiments, the two segments are joined by articulated joint means comprising a spring blade, fixed by adhesive, welding, or snap-fastening to the bottom walls or to one of the flanges of the two hinged segments, the resilience of this blade allowing one segment to turn through 180° relative to the other.

In a sixth series of embodiments, the cableway comprises at least an inner, first segment slidably mounted relative to an outer, second segment, the inner and outer segments being substantially geometrically similar in shape over the major fraction of their profiles, locking means serving to prevent one segment from moving relative to the other at the end of their stroke. The term “end-of-stroke” is used herein to mean telescoping the segment to the length desired by the fitter.

In a particular embodiment, the flanges of the inner and outer segments are provided with respective steps preventing the inner segment moving vertically relative to the outer segment.

In each of the embodiments described above, at least one of the two segments is based on a bare or lined wire basket structure, or on an optionally perforated sheet.

In other embodiments, the end portions of the two segments are wire baskets, and the articulated joint means comprise the following elements, singly or in combination:

a joint loop or strip connecting together the end weft wires of the segments via their base portions constituting the bottom walls of said segments;

at least two projecting end portions of the warp wires of at least one of the segments, said end portions being curved into S-shapes; and

a portion of reduced thickness of the warp wires in at least one zone of the bottom walls or one of the flanges of said segments.

By way of example, the means for locking the end portions of the segments in the longitudinally-aligned position comprise a bar held pressed between the warp wires of contiguous flanges of the two segments, said bar being mounted in articulated manner to both of the segments.

Where appropriate, a resilient strip on at least one of the flanges of the segments clamps together the end weft wires of the segments placed facing each other, when the end portions of the segments are in their longitudinally-aligned position.

In each of the above embodiments, at least one of the segments is advantageously provided with projections on the bottom face of its bottom wall, these projections forming abutment means which press against the inside face of the segment placed beneath it in the stack when the segments are stacked.

### BRIEF DESCRIPTION OF THE DRAWINGS

Other objects and advantages of the invention appear from the following description of embodiments, which description is given with reference to the accompanying drawings, in which:

FIG. 1 is a perspective view of the end portion of the joint between two cableway segments, in a first embodiment;

FIG. 2 is a side view of the joint end portion of two cableway segments in a second embodiment, these end portions being shown in an intermediate position between the transport position and the longitudinally-aligned, locked position;

FIG. 3 is a side view analogous to that of FIG. 2, showing the joined end portions of two cableway segments in the longitudinally-aligned and locked position;

FIG. 4 is a side view of a joint piece of the type used in the embodiment of FIGS. 2 and 3, this joint piece being shown on its own, separate from the cableway segments;

FIG. 5 is a view of the piece shown in FIG. 4 as seen from beneath;

FIG. 6 is a cross-section view on plane VI-VI of FIG. 5;

FIGS. 7, 8, and 9 are side views analogous to the view of FIG. 4, showing three variant embodiments of cableway joint pieces;

FIG. 10 is a perspective view of an end portion of a cableway segment suitable and designed for receiving, on its inner face of at least one of its flanges, a joint piece as shown in FIGS. 4 to 9;

FIG. 11 is a side view of the end portion of two joined-together cableway segments in a third embodiment, these end portions being shown in an intermediate position between the transport position and the cableway-mounted position;

FIG. 12 is a side view analogous to that of FIG. 11, with the joined-together end portions of the two cableway segments being shown in longitudinal alignment, in the locked and mounted position of the two segments;

FIG. 13 is a cross-section view on plane XIII-XIII of FIG. 12;

FIG. 14 is a longitudinal section view of the articulated joint end portions of two cableway segments in a fourth embodiment, the joined-together end portions of the two segments being shown in their relative positions for transport or storage;

FIG. 15 is a side view of the joined-together end portions of the two cableway segments of FIG. 14, the end portions being shown in their longitudinally-aligned and locked position;

FIG. 16 is a side view of the joined-together end portions of the two cableway segments of FIGS. 14 and 15, these end portions being shown in an intermediate, pivot position;

FIG. 17 is a cross-section view of two segments joined together by means of the kind shown in FIGS. 14 to 16, the two segments being shown in their folded relative position for transport or storage, with the flanges of the segments being elastically interfitted;

FIG. 18 is a side view of a variant embodiment of means for joining together two cableway segments, the joined-together end portions of the two segments being in their longitudinally-aligned, locked position with a separate resilient piece fitted thereto;

FIG. 19 is a view analogous to FIG. 18, with a shorter link piece integral with one of the two segments;

FIG. 20 is a detail view of the separate joint piece shown in FIG. 18;

FIG. 21 is a plan view of two end portions of two cableway segments provided with separate, fitted, joining and locking means in a sixth embodiment;

FIG. 22 is a side view and a cross-section view of the two end portions of the segments shown in FIG. 21;

FIGS. 23, 24, and 25 are side views analogous to the view of FIG. 22 showing the end portions of the segments respectively in the folded position for storage and transport (FIG. 23), in the deployed position where they are locked in longitudinal alignment (FIG. 24), and in an intermediate, pivot position (FIG. 25);

FIG. 26 is a plan view of two cableway segments joined to an intermediate segment, the assembly being shown in an intermediate, pivot position, in a seventh embodiment;

FIG. 27 is a view analogous to FIG. 26, the segments being shown in a folded position for storage or transport;

FIG. 28 is a view analogous to the views of FIGS. 26 and 27, with the segments being shown in their in-use, deployed position where they are locked in longitudinal alignment;

FIG. 29 is a detail view of the locking means implemented in the embodiments of FIGS. 26 to 28;

FIG. 30 is a plan view of a cableway segment made of sheet metal joined by a transverse line of weakness in an eighth embodiment;

FIG. 31 is a side view of the joined-together end portion of two cableway segments in a ninth embodiment, the two end portions of the segments being shown in their folded position for storage or transport;

FIG. 32 is a side view of the joined-together end portions of the two cableway segments shown in FIG. 31, the two end portions being shown locked together in longitudinal alignment;

FIG. 33 is an end view of FIG. 31;

FIG. 34 is a fragmentary plan view of a cableway segment provided with means for facilitating stacking and unstacking;

FIG. 35 is a side view of the segment shown in FIG. 34;

FIG. 36 is a diagrammatic section view of three segments of the type shown in FIGS. 34 and 35, these three segments being stacked together;

FIGS. 37, 38, 39, and 40 are a cross-section view (FIG. 37) and half cross-section views (FIGS. 37, 39, and 40) of cableway segments in a tenth embodiment;

FIGS. 41 and 42 are respectively a diagrammatic side view and a perspective view showing means for joining together two cableway segments in an eleventh embodiment;

FIG. 43 is a side view of the joined-together end portions of two cableway segments shown in their position where one is folded on the other;

FIG. 44 is a plan view of the joined-together end portions of the two cableway segments of FIG. 43, the two end portions being shown in their aligned position for mounting;

FIG. 45 is a side view showing a detail of the joining means in the longitudinally-aligned position between the two end portions of the segments shown in FIGS. 43 and 44;

FIG. 46 is a longitudinal section view of two joined-together cableway end portions in a twelfth embodiment, these joined-together end portions being shown in the longitudinally-aligned, deployed position;

FIG. 47 is a view analogous to the view of FIG. 46, with the two end portions being shown in the folded position for storage or transport;

FIG. 48 is a section view on plane AA of FIG. 46;

FIG. 49 is a longitudinal section view of a cableway segment provided with hinge means in a thirteenth embodiment;

FIGS. 50 and 51 are longitudinal section views of two joined-together cableway end portions in a fourteenth embodiment, these hinged-together end portions being shown in the longitudinally-aligned, deployed position (FIG. 50) and in an intermediate relatively-pivoted position (FIG. 51);

FIG. 52 is a fragmentary perspective view of two joined-together end portions of cableway segments in a fifteenth embodiment, the end portions being shown in their longitudinally-aligned, locked position;

FIG. 53 is a fragmentary cross-section on plane CIII-CIII of FIG. 52;

FIG. 54 is a detail view of the joining and locking means used in the embodiment shown in FIGS. 52 and 53;

FIG. 55 is a fragmentary perspective view of two joined-together end portions of cableway segments shown in an intermediate, relatively-pivoted position;

FIG. 56 is a fragmentary view seen looking along direction CVI in FIG. 55;

FIG. 57 is a side view of two cableway segments, these two segments being shown separately in cross-section in their mounting position in FIGS. 58 and 59;

FIG. 60 is an end view of two cableway segments shown folded one in the other, in another embodiment;

FIGS. 61 and 62 are a side view (FIG. 62) and a section view (FIG. 61) showing the end portions of cableways provided with joining means, these two end portions being shown in the longitudinally-aligned, deployed position (FIG. 61) and in a non-coupled position (FIG. 62);

FIG. 63 shows an embodiment of means for locking cableway segments in longitudinal alignment, at least one of the flanges of the segments being provided with longitudinally-extending slots; and

FIGS. 64 to 67 are cross-section views and fragmentary side views of various embodiments of tongues, projections, or portions in relief for locking joined-together cableway segments in longitudinal alignment.

### MORE DETAILED DESCRIPTION

Each of the cableway segments shown in the accompanying figures comprises a web or bottom wall and two side flanges.

In the description below, terms such as “length” and “longitudinal” are used with reference to a first direction D1 in which the cableway segments extend.

Terms such as “width”, “transverse” are used to refer to a second direction D2 perpendicular to the first direction D1, the directions D1 and D2 defining a plane substantially parallel to the bottoms of the cableway segments in the mounted position.

Terms such as “height”, “vertical” are used to refer to a third direction D3, the directions D1, D2, and D3 forming a conventional rectangular frame of reference.

The use of terms such as “height”, “vertical” in the description below should not be understood as imposing any particular mounting position on the cableways, and it should be understood that the cableways shown in the accompanying figures can be placed with their bottom walls horizontal, sloping, or vertical.

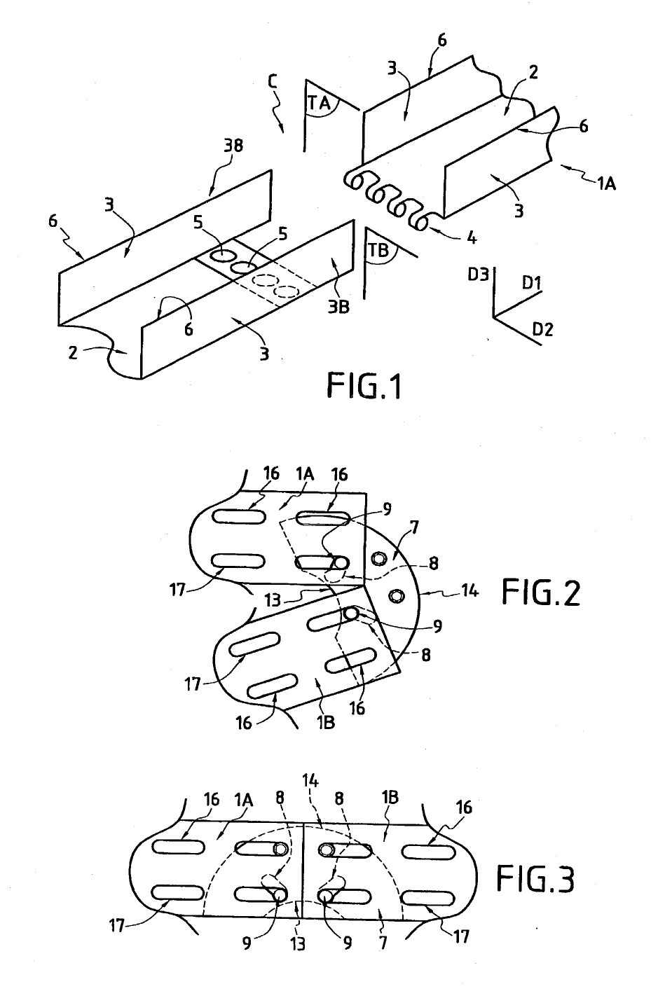

Reference is now made to FIG. 1.

Each of the end portions of the cableway segments 1A and 1B shown in FIG. 1 comprises a bottom wall 2 and two flanges 3 that are substantially parallel to each other and perpendicular to the bottom wall 2.

The segment referenced 1A is provided on its bottom wall 2 with hook-shaped projections 4, while the segment referenced 1B is provided in its bottom wall with through holes 5.

The hook-shaped projections 4 project beyond a transverse plane TA that is tangential to the vertical free edges of the flanges 3 of the segment 1A.

The through holes 5 are placed in the bottom wall 2 of the segment 1B, being set back from the transverse plane TB tangential to the vertical free edges of the flanges 3 of the segment 1B.

Thus, when the hooks 4 are placed in the holes 5, and the segments 1A and 1B are in alignment, the ends 3B of the flanges of the segment 1B face and press against the flanges 3 of the segment 1A.

The friction between the flanges of the segments 1A and 1B during pivoting of the segments relative to each other generate resistive torque which limits the risk of one of the segments moving suddenly relative to the other.

Snap-fastening means, or any other equivalent means serve to lock the segments 1A and 1B together in the longitudinally-aligned, mounted position.

Engaging the projections 4 in the through holes 5 serves to constitute a hinge C between the two cableway segments 1A and 1B.

In the embodiment of FIG. 1, the segment 1A is provided with four hook-shaped projections 4, while the segment 1B being provided with four complementary through holes 5.

In other embodiments (not shown), the number of projections and holes could be other than four, for example two projections and two holes could be provided.

The segment 1A may be provided in its transverse edge remote from the edge shown in FIG. 1 with through holes 5 of the kind shown for the segment referenced 1B.

In such a design, each segment 1A and 1B is provided with one male transverse edge from which the hooks 4 project and with one female transverse edge in which the through holes 5 are formed.

In another embodiment, the segments 1A are provided on both opposite transverse edges with hook-shaped projections 4, while complementary female segments 1B are provided at both opposite transverse edges with through holes 5.

The sheet cableway segments 1A and 1B can be obtained by folding an optionally-perforated sheet metal blank, with reinforcing ribs being incorporated, where appropriate, in the bottom wall and/or the side flanges.

The longitudinal top edges 6 of the flanges 3 are advantageously rounded, e.g. by being folded over towards the inside of the cableways or towards the outside. Such rounded edges present several advantages:

improved stiffness in bending for the cableway;

the sheaths of cables are protected from the possibility of being injured on the longitudinal free edges of the flanges since said free edges face towards the bottom wall of the segment, or else are turned through more than 90° towards the inside wall of the flange in the manner described in the Applicants' document FR-A-2 739 168; and

a groove is defined that is open towards the bottom wall of the segments, which groove is suitable for receiving a fishplate, e.g. in the form of a wire.

In other embodiments (not shown) a hinge is fitted to the bottom walls 2 of the segments 1A and 1B, with each of the segments 1A and 1B carrying one of the leaves of the hinge, a pin or peg passing through the knuckles projecting from the leaves.

The hinge as constituted in this way be one of the following types: hinges having blank leaves for drilling and countersinking from either face, hinges having leaves in the form of sheets folded in half, hinges having leaves that are offset when parallel, hinges with leaves tapering away from their hinge pins, hinges having pairs of parallel pins interconnected by links, single- or double-acting spring hinges, piano hinges.

When a hinge with two leaves and a pin is put into place, the two segments 1A and 1B can be transported or stored folded one on the other.

When the knuckles are made using the sheet metal of the cableway segments, a pin can be inserted so as to constitute a hinge, and the two segments can be transported and stored while not coupled together or else while joined together and folded one on the other.

Reference is now made to FIGS. 2 to 10 which show a second embodiment.

In this second embodiment, the flanges or the bottom walls of each cableway segment 1A and 1B are fitted with a link piece 7 placed on the inside faces of said flanges 3 or said bottom walls 2.

In the first variant embodiment shown in FIGS. 2 to 5, this link piece includes:

firstly two slots 8 that are inclined relative to a transverse plane of symmetry S, the slots 8 cooperating with pins 9 presented by the pivoting segments 1A and 1B; and

secondly at least one stud 10 engaging in a recess or through hole formed in the cableway segments.

In the variant embodiments of FIGS. 7 and 9, a single slot 8 receives both of the pins 9 carried by the pivoting segments 1A and 1B.

In the embodiment shown in FIGS. 2 to 5, two studs 10 are carried by the link piece 7, these studs 10 being placed substantially symmetrically about the transverse plane S.

By way of example, the studs 10 are obtained by stamping the plane plate that forms the piece 7, as can be in FIG. 5.

The slot(s) 8 is/are oblong having two support and locking abutments 11, i.e. one abutment 11 for each of the two pins 9.

In a particular embodiment, at least one link and locking piece 7 is disposed substantially parallel to a flange 3 on each of the two segments 1A and 1B, on the inside face of the flange 3.

As can be seen in FIG. 10, in order to allow one of the segments 1A to pivot substantially through 180° relative to the other segment 1B, each end portion of the two segments is provided with at least one longitudinal slot 12 through which the link piece 7 passes.

The end portion of the segment 1A, 1B shown in FIG. 10 is provided with two substantially identical longitudinal slots 12, each disposed in its bottom wall 2 immediately adjacent the flanges 3, thus accommodating movement and passage of a link piece 7 against either one of the two flanges, or indeed against both of the two flanges 3.

The link pieces 7 are substantially plane and in the form of a half-disk (FIG. 7) or in the form of a half-ring (FIGS. 2 to 4, 8, and 9).

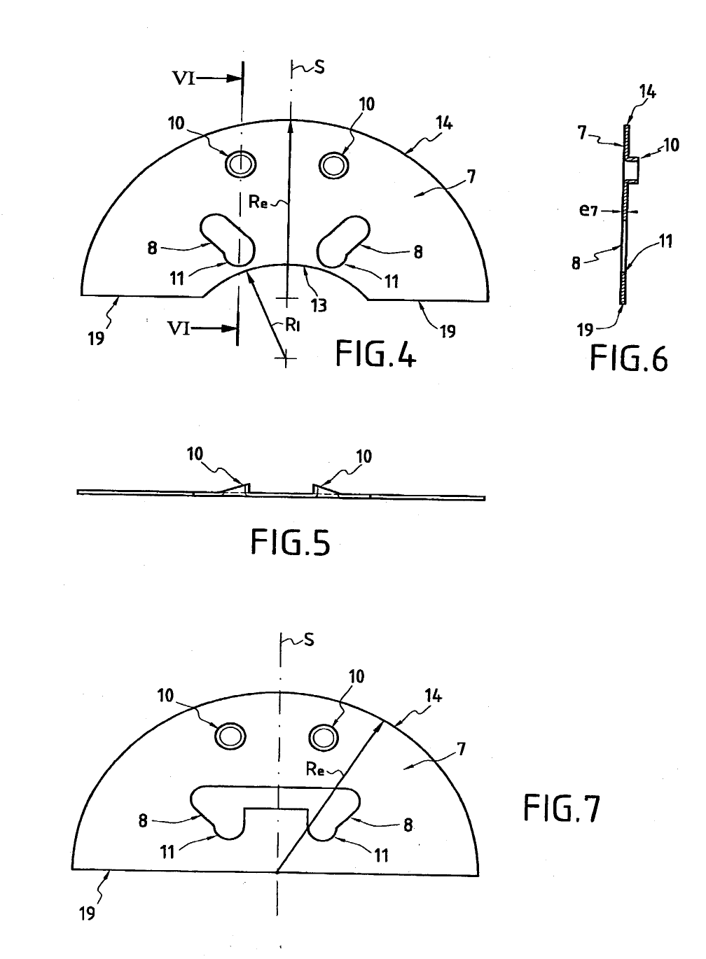

More precisely, as can be seen in FIGS. 4, 8, and 9, the link pieces in the form of half-rings have both a central bottom curved edge 13, of substantially constant radius of curvature Ri, and a top curved edge 14 of substantially constant radius of curvature Re, the centers of curvatures C13 and C14 advantageously not coinciding but being spaced apart.

The length L12 of the through slots 12 can thus be as short as possible so as to avoid weakening the cableway segments.

The width 1a12 of the through slots 12 is substantially equal to the thickness e7 of the link piece, ignoring operating clearance.

When, as shown in FIG. 10, the top longitudinal edges 6 of the flanges 3 are folded over through 180° so as to form respective grooves 15 that are open towards the bottom wall 2, the substantially constant radius of curvature Re of the top curved edge 14 of the link piece 7 is advantageously substantially equal to or slightly less than the height H between the base wall 2 and the bottom of the groove 15.

The curved edge 14 of the link piece 7 is thus received and guided in the longitudinal groove 15 during pivoting movement of one segment 1A relative to the other segment 1B.

Engaging the studs 10 in the recesses 16 of the flanges 3 of each of the segments 1A and 1B causes the two segments 1A and 1B to be locked in longitudinal alignment, as shown in FIG. 3.

In the embodiment shown, the recesses 16 are oblong longitudinal perforations that are substantially identical to those referenced 17 in which the hinge pins 9 are received. The perforations 16 and 17 are substantially parallel and identical, thus reducing the number of operations needed for manufacturing cableways.

Where appropriate, respective fishplates may be placed on the outside faces of the flanges of the segments 1A and 1B in order to further reinforce locking in longitudinal alignment.

The link pieces 7 participate in various functions:

a function of enabling the segments 1A and 1B to be articulated from a compact, folded position to an in-use, aligned position;

a function of locking the two segments in the longitudinally-aligned position; and

a function of transferring loads.

Load transfer is associated:

with the pins 9 bearing against the longitudinal holes 17 in the flanges 3 of the segments and against the support abutments 11 of the slots 8;

with catches 18 bearing against housings or perforations in the flanges of the segments, the catches 18 being deformed elastically during pivoting of one segment 1A relative to the other segment 1B, the folded-over longitudinal top edges of the flanges forming the guide grooves for the link pieces; and

with the bottom edge 19 possibly bearing against the bottom walls 2 of the segments.

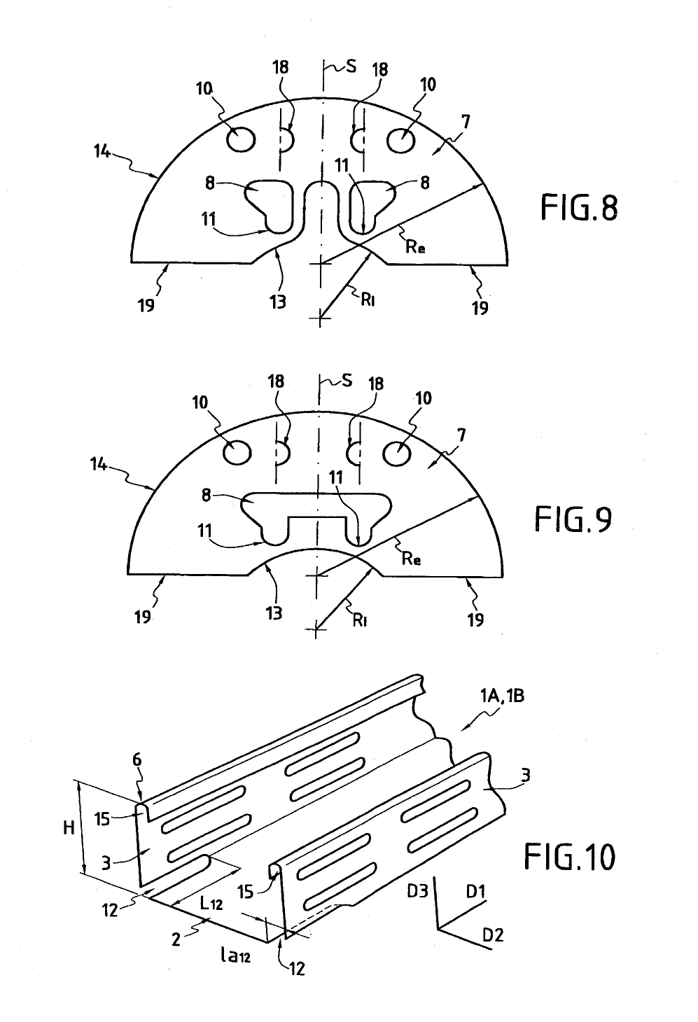

The catches 18 and the studs 10 of the link pieces 7 shown in FIGS. 8 and 9 are disposed in two pairs. In each pair, the catch 18 is offset from the stud by a distance such as to enable both of them to be received in a single perforation or buttonhole 16 in one of the segments 1A or 1B.

When the two segments 1A and 1B are in the folded position, one against the other, for storage or transport purposes, means may be provided for holding them temporarily in the folded position, where appropriate, so as to prevent the two segments 1A and 1B from moving apart and pivoting in unwanted manner relative to each other. Thus, the bottom walls of the segments 1A and 1B may include projections for mutual snap-fastening in relatively weak manner.

It should be observed that the link piece does not project significantly beyond the tangential plane extending transversely to the ends of the segments 1A and 1B when the segments are folded one against the other, since the link piece passes through the longitudinal slots 12.

Link pieces may be placed substantially parallel to one or both flanges of the segments. In another embodiment, a link piece as shown in FIGS. 4 to 9 is placed substantially parallel to the bottom walls 2 of the two segments which are thus mounted to pivot about an axis that is substantially perpendicular to said bottom wall. A longitudinal slot analogous to that shown in FIG. 10 then extends over a height that is substantially equal to the thickness of the link piece, ignoring operating clearance. Through holes analogous to those referenced 16 and 17 in FIGS. 2 and 3 are located in the bottom walls of the segments and enable the two segments to be locked together in longitudinal alignment in a manner similar to that described above.

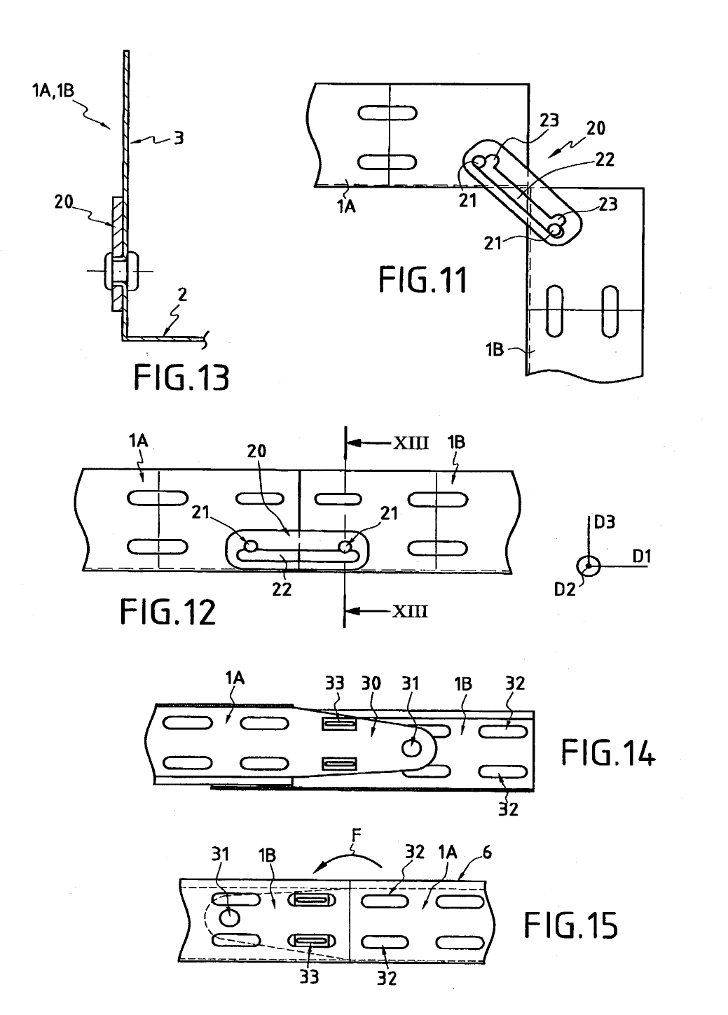

Reference is now made to FIGS. 11 to 13 which show a third embodiment.

In this embodiment, at least one flange of each cableway segment 1A and 1B is fitted with a link piece 20 that is mounted on the outside faces of the segments 1A, 1B.

Each of the segments 1A and 1B carries an outwardly projecting pin 21 on its flanges.

The link pieces 20 present respective elongate slots 22 in which the pins 21 can slide and becoming engaged in notches 23.

The distance between the notches 23 is substantially equal to the spacing between the pins 21, which spacing is measured when the segments 1A and 1B are locked together in the longitudinally-aligned position, as shown in FIG. 12.

The length of the slot 22 is greater than the distance between the notches 23 so as to allow the two segments 1A and 1B to pivot relative to each other.

While pivoting, the pins 21 move along the slot 22 and are then received in the notches 23, enabling the segments to be locked together.

The link piece 20 is placed low down the segments 1A and 1B and locking can thus be obtained purely under the effect of gravity.

Where appropriate, additional locking can be obtained using a fishplate.

The pins 21 can be obtained by riveting a stamping formed in each flange 3 of the segments 1A and 1B.

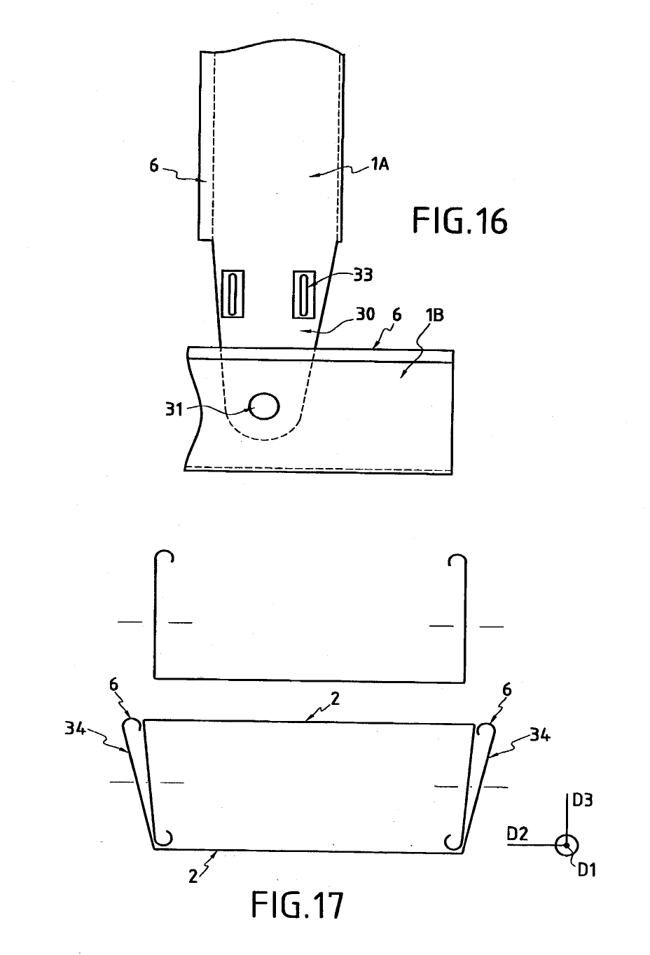

Reference is now made to FIGS. 14 to 17 which show a fourth embodiment.

In this embodiment, the flanges 3 of a first cableway segment 1A are provided with respective longitudinal projections 30 integral therewith or fitted thereto to form a support for a transverse pin 31.

When the two segments 1A and 1B are in their extreme deployed position so that they are longitudinally aligned with each other, as shown in FIG. 15, locking means are provided for preventing any pivoting as represented by arrow F.

One embodiment of these locking means is shown in FIG. 15. The locking means comprise firstly through holes or setbacks 32 which are analogous to those referenced 16 and 17 in FIGS. 2 and 3, and which are therefore not described again.

The locking means also comprise projections 33 disposed on the flanges of a first segment and received in abutment in the through holes carried by the flanges of the second segment.

While the two segments 1A and 1B are being transported or stored, the flanges 34 of the second segment are deformed by being inserted by force into the first segment, or vice versa, as shown in FIG. 17.

In the embodiment shown, this deformation is associated with the following combination:

the sheet metal cableway segments are channel-section members, each having two flanges substantially perpendicular to a bottom wall; and

the top longitudinal edges of the flanges are folded over towards the insides of the segments, with the advantages of such folded-over longitudinal edges being as described above.

Naturally, the deformation of the flanges 34 of the segment could be maintained elastically.

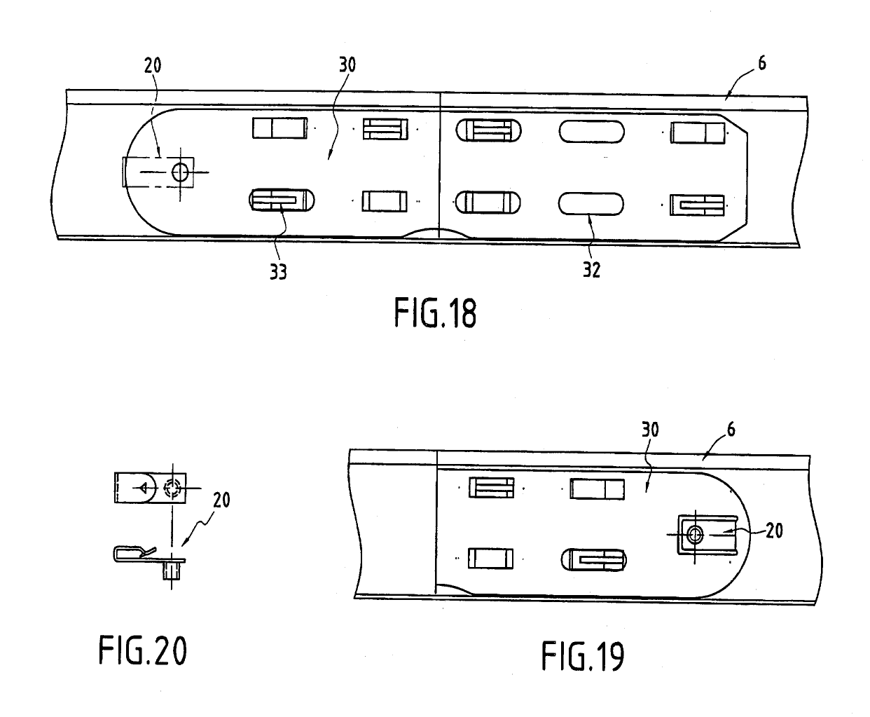

The pin 31 must enable the two segments to be moved away from their storage position as shown in FIG. 17 to their locked position in longitudinal alignment as shown in FIG. 15. For this purpose, the pin is elastic along its longitudinal axis, which elasticity may be obtained, for example, by a spring-bolt mount or by an integral spring blade type mount (see Reference 20 in FIG. 19) or by a spring blade mounted separately (see Reference 20 in FIGS. 18 and 20).

Such mounting is shown in FIGS. 18 to 20.

In a variant, or in combination, the top free edges of the flanges of the segments may be folded over outwardly.

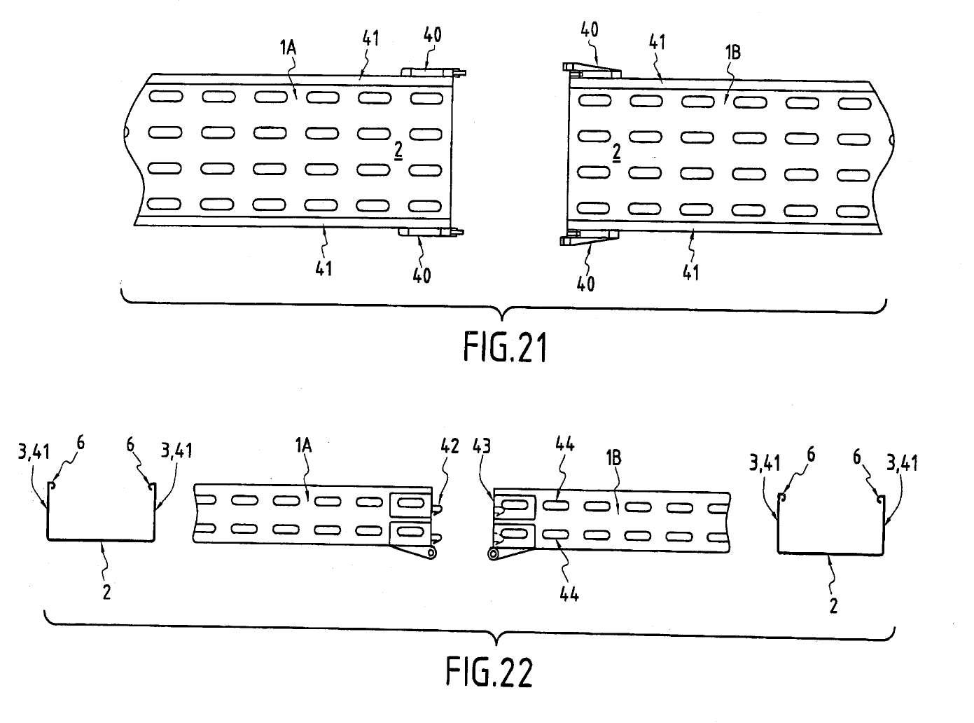

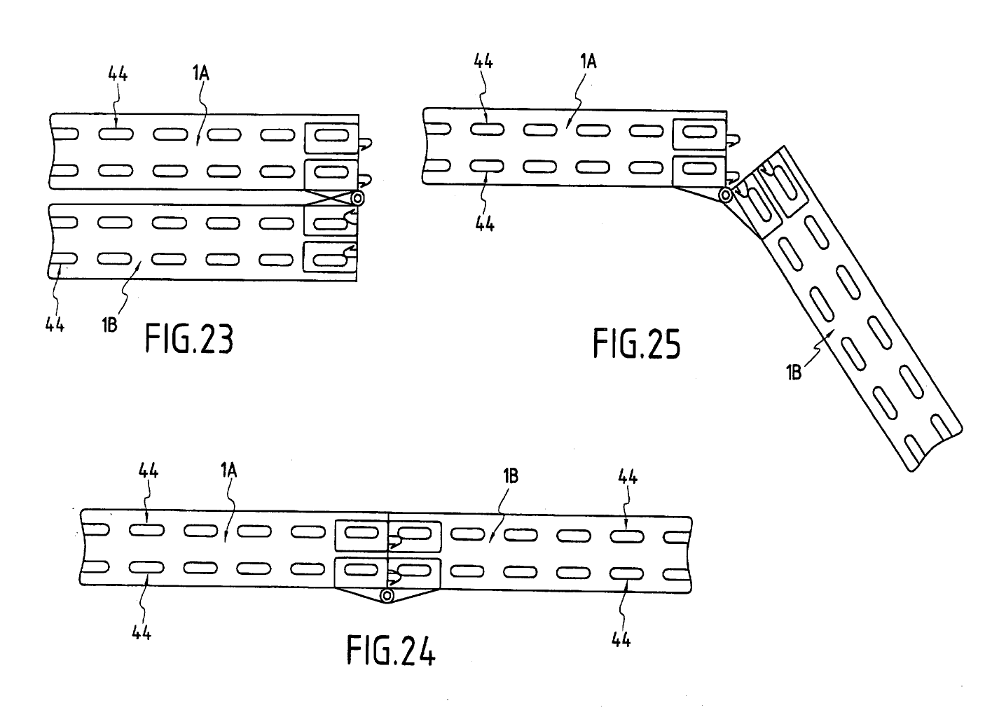

Reference is now made to FIGS. 21 to 25 which show a sixth embodiment.

Each of the sheet cableway segments 1A, 1B is provided with projections supporting pins 40 disposed on the flanges 41 of the segments.

Hook- or barbed-shaped longitudinal projections 42 enable the two segments 1A and 1B to snap-fasten and lock together in the longitudinally-aligned position, the projections 42 penetrating into setbacks 43.

The pins 40 and the projections 42, together with the setbacks 43, are carried in the embodiment shown in FIGS. 21 to 24 by pieces that may be separate fittings or may be formed integrally on the flanges 41 of the cableway segments, these flanges being provided with through holes 44 which are similar to those referenced 16 and 17 in FIGS. 2 and 3, and with upper folded-over longitudinal edges 6 with the advantages as described above.

In the embodiment shown in FIG. 21, the bottom walls 2 of the segments 1A and 1B are provided with perforations of shape and distribution identical to those of the flanges 41, thus enabling manufacturing costs to be reduced. Naturally, where appropriate, and as a function of requirements, the bottom walls of the segments 1A and 1B could be provided with perforations disposed in some other pattern, for example having holes that are round and/or holes that are oblong in the transverse direction.

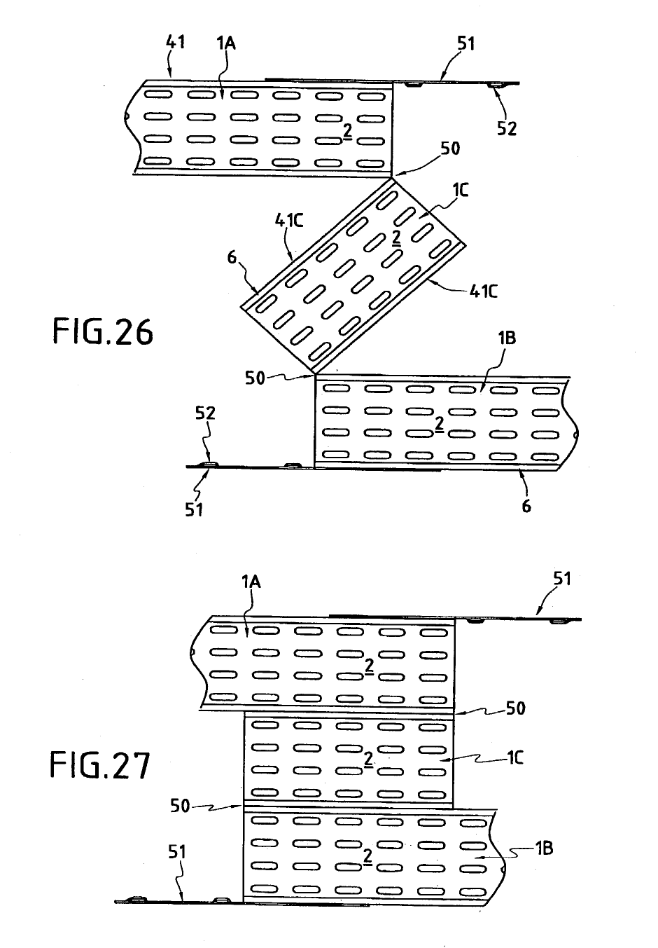

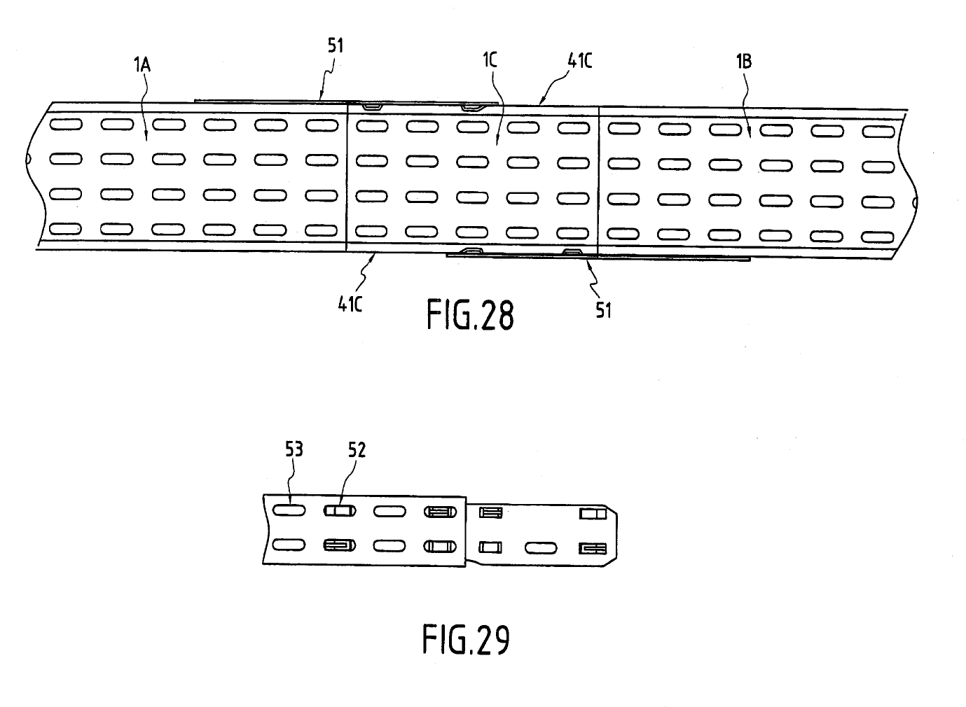

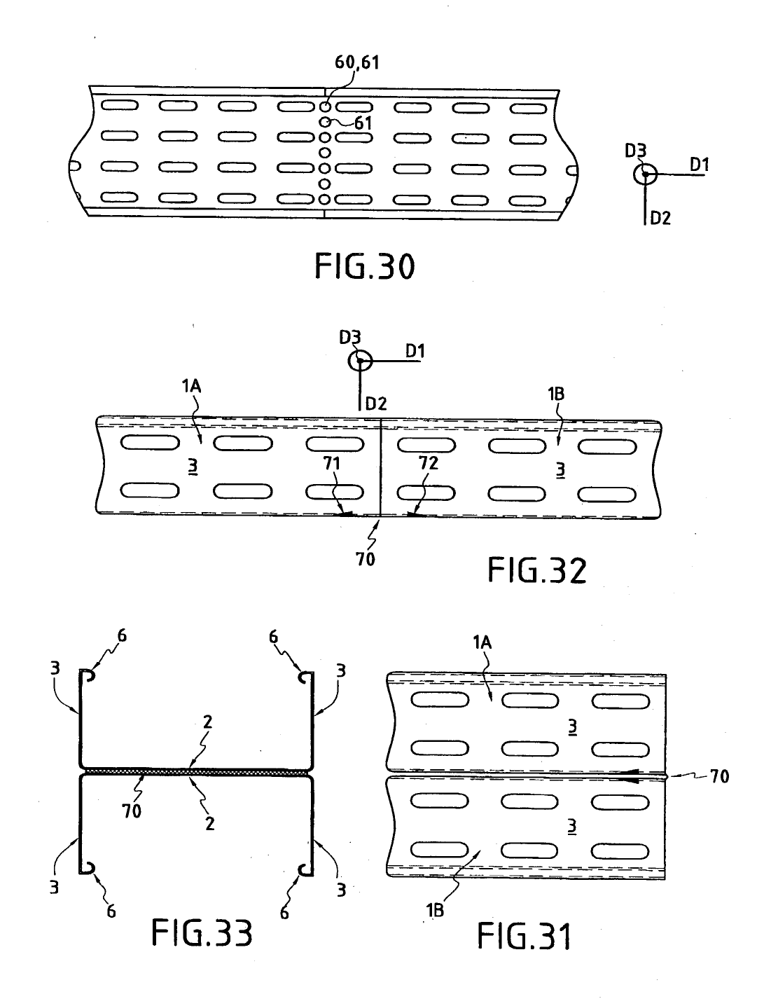

In the seventh embodiment shown in FIGS. 26 to 29, the cableway segments 1A and 1B are joined together by means such as hinges, thin-walled portions (as shown in FIG. 30) or a joint as shown in FIG. 1, disposed on the flanges 41 of the segments 1A and 1B, and connecting each of them to an intermediate segment 1C.

In the embodiment shown, each of the three segments 1A, 1B, and 1C comprises a bottom wall 2 and two perforated flanges 41 having folded-over top edges 6, as described above. Nevertheless, it should be understood that, where appropriate, and as a function of requirements, the three segments could be provided with bottom walls that differ concerning their perforations and/or their type (solid or perforated sheet, expanded metal, welded basket).

Advantageously, going from one segment to another, the hinges 50 are disposed in alternation on the right flange and on the left flange so as to enable a Z-shaped fold to be used during storage or transport.

The means for locking the segments 1A, 1B, and 1C in the longitudinally-aligned position as shown in FIGS. 26 to 29 are of the projecting fishplate type 51 or of the telescopic fishplate type, provided with projections, flexible tabs, or studs 52 suitable for and disposed so as to be received in the perforations 53 in the flanges 41C of the segment 1C.

In the embodiment of FIG. 30, a transverse line of weakness 60 enables a cableway segment to be unfolded through an angle of about 180°.

By way of example, this line of weakness can be formed by perforations 61 of various shapes (round, square, rectangular, oblong), in alignment and/or by a stamping or by including a slot.

Locking means such as those referenced 42 and 43 in FIG. 22 or such as those referenced 30 and 33 in FIGS. 14 and 18 are placed on at least one of the flanges of the cableway in one embodiment.

Reference is now made to FIGS. 31 to 33.

The cableway segments 1A and 1B shown in FIGS. 31 to 33 are joined together and interconnected by a resilient blade 70 suitable for being folded through about 180°.

In an embodiment, the end portions of the blade 70 are stuck to the bottom walls 2 or to one of the flanges of the segments 1A and 1B.

In another embodiment, the end portions 71 and 72 of the blade 70 are hook- or barbed-shaped and are snap-fastened in housings disposed in the bottom walls or in one of the flanges of the two segments 1A and 1B.

The blade is advantageously made of a material that is highly elastic, such as an elastomer or spring steel.

In the embodiment shown in FIG. 33, the blade 70 extends over a width that is substantially equal to the width of the bottom walls of the segments.

Where appropriate, and in particular when the segments are long, for example more than three hundred millimeters long, a plurality of spring blades may be used.

The segments 1A and 1B can be locked in longitudinal alignment by using one or two link pieces 7 as shown in FIG. 4, or as shown in FIGS. 7 to 9, or 11 to 13.

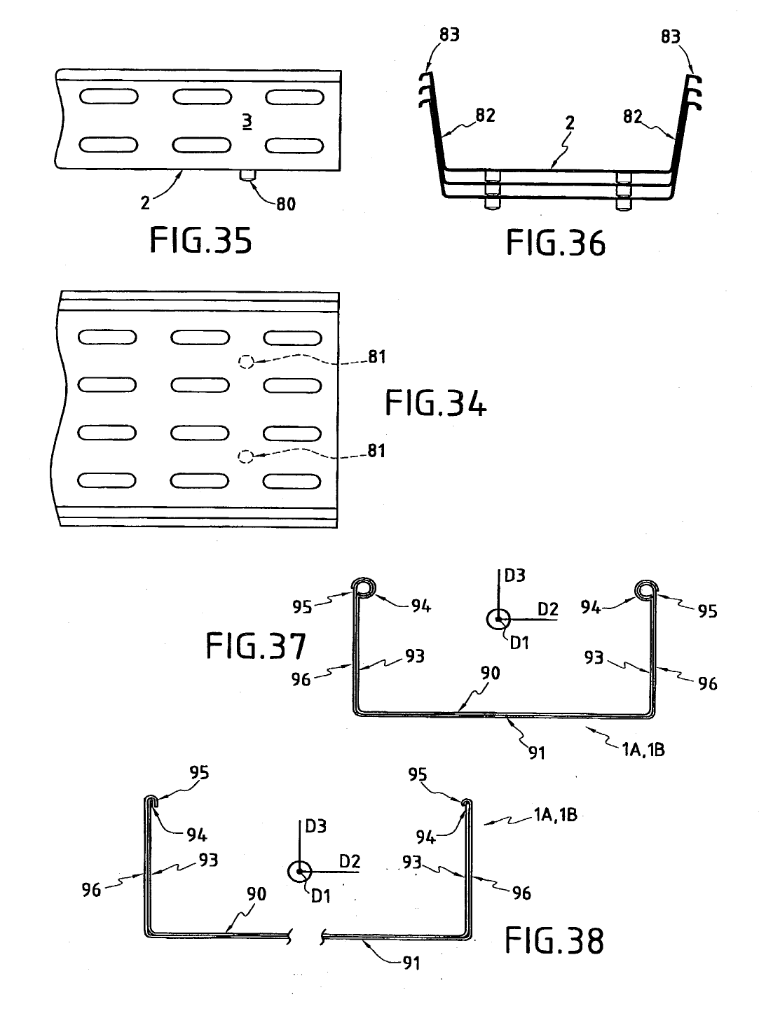

In the embodiment of FIGS. 34 to 36, the sheet cableway segments are provided in their bottom walls 2 with projections 80 that bear against shallow depressions 81 when the segments are stacked.

Two such bearing zones 81 can be seen in FIG. 34. The number of projections 80 may be greater than two, for example when the segments are of great width.

The projections 80 and the depressions 81 serve simultaneously:

to ensure that the segments are relatively positioned longitudinally one in another, thus preventing them sliding longitudinally relative to one another during transport; and

that the bottom walls 2 are spaced apart when the segments are stacked together, thus reducing any risk of jamming and making unstacking easier.

The projections and the depressions 80 and 81 may be combined with the joints, e.g. as shown in FIG. 1 in particular.

In order to make stacking easier, the flanges 82 of the segments slope relative to the vertical, and the top longitudinal edges 83 of the flanges 82 are folded over outwardly.

FIGS. 37 to 40 show embodiments in which the cableway segments 1A and 1B are slidable relative to one another. The inner segment 90 may be substantially geometrically similar to the outer segment 91, as shown in FIGS. 37 to 40, the flanges of the segments being:

substantially plane and vertical, with free edges folded over inwardly or outwardly; or

provided with a setback 92 and a top free edge that is not folded over, the setback preventing one segment from moving vertically relative to the other.

More precisely, in the embodiment of FIG. 37, the inner segment 90 has two substantially symmetrical flanges 93 each provided with a folded-over top longitudinal edge that is C-shaped and referenced 94.

This folded-over longitudinal edge 94 presents all of the advantages set out above with reference to the edge 6 for the embodiment of FIG. 1.

In addition, this folded-over longitudinal edge 94 forms a slideway for guiding the folded-over top longitudinal edge 95 of the corresponding flange 96 of the outer segment 91.

The folded-over top longitudinal edge 95 naturally itself presents all of the advantages set out above with reference to the edge 6 of the embodiment of FIG. 1 (increased stiffness for the cableway, protecting cable sheaths while they are being laid, in particular).

The longitudinal edge 95 of each flange 96 of the outer segment 91 is placed to slide inside the longitudinal edge 94 of the corresponding flange 93 of the inner segment 90.

In the embodiment of FIG. 38, the longitudinal edges 94 and 95 of the inner and outer segments are:

curved through substantially 1800, the edge 94 of the inner segment 90 being slidably received in the edge groove 95 of the outer segment 91 (the variant shown in the left-hand portion of FIG. 38); or

respectively not folded over for the edge 94 of the inner segment 90 and folded through substantially 180° for the edge 95 of the outer segment 91, the edge 94 of the inner segment 90 being slidably received in the groove defined by the folded-over edge 95 of the outer segment 91 (variant shown in the right-hand portion of FIG. 38).

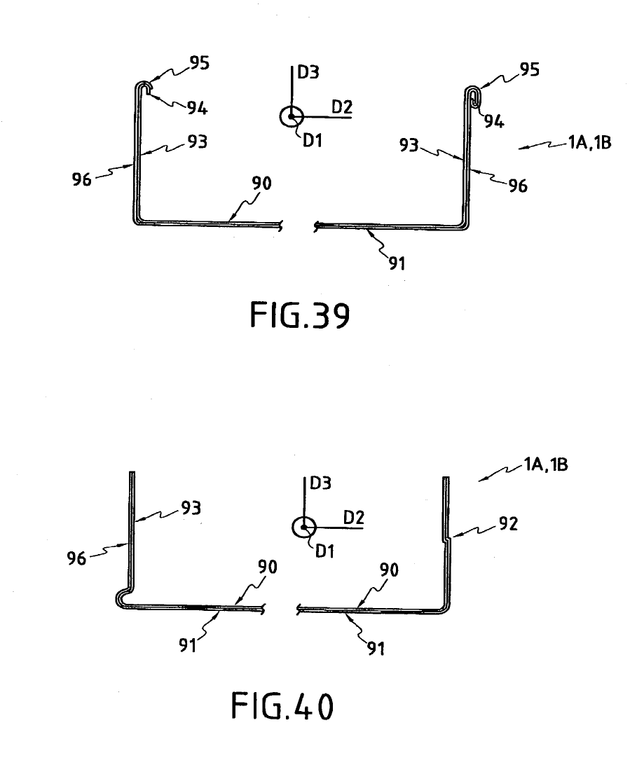

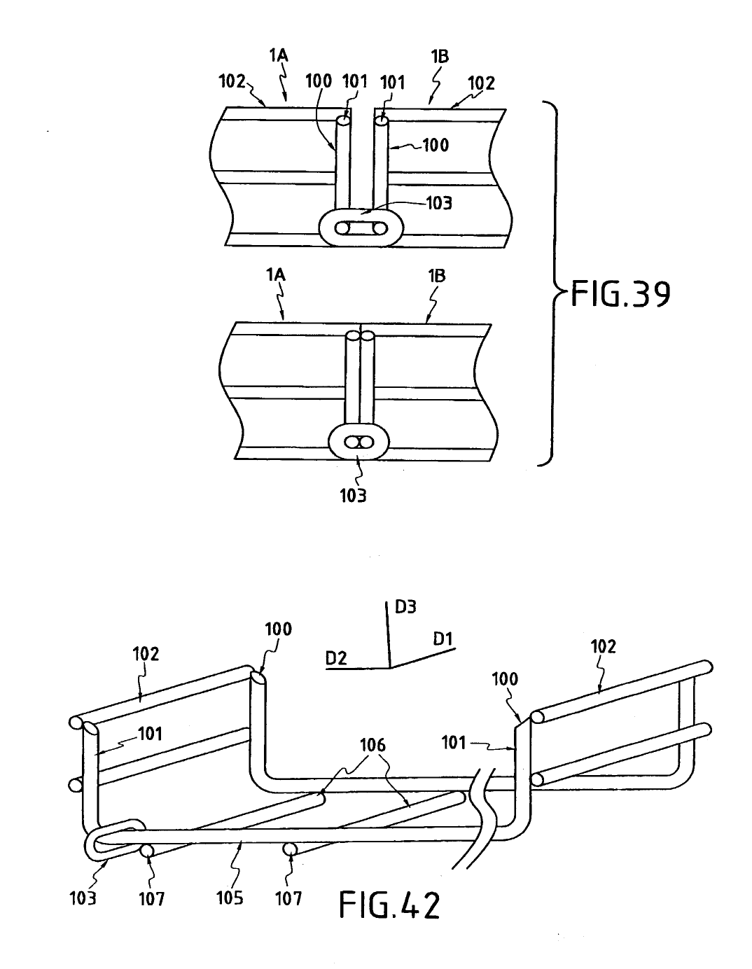

In the embodiment of FIG. 39, the top longitudinal edge 94 of each flange 93 of the inner segment 90 is not folded over so as to be pressed against the inside face of the flange 93 (unlike the embodiment shown in the left-hand portion of FIG. 38), but forms a downwardly open longitudinal groove that is substantially geometrically similar to that formed by the folded-over edge 95 of each flange 96 of the outer segment 91.

The folded-over edges 94 and 95 may be folded over inwardly (FIG. 39, left-hand portion), or outwardly (FIG. 39, right-hand portion).

FIG. 40 shows the disposition of a step 92 in one of the flanges of each of the segments 90 and 91, or indeed at the base 97 of the flanges 93 and 96. This step or longitudinal setback 92, 97 serves to guide the segments in sliding and to prevent one of the segments moving vertically relative to the other.

In this case, there is no need to provide folded-over top edges on the flanges of the sliding segments.

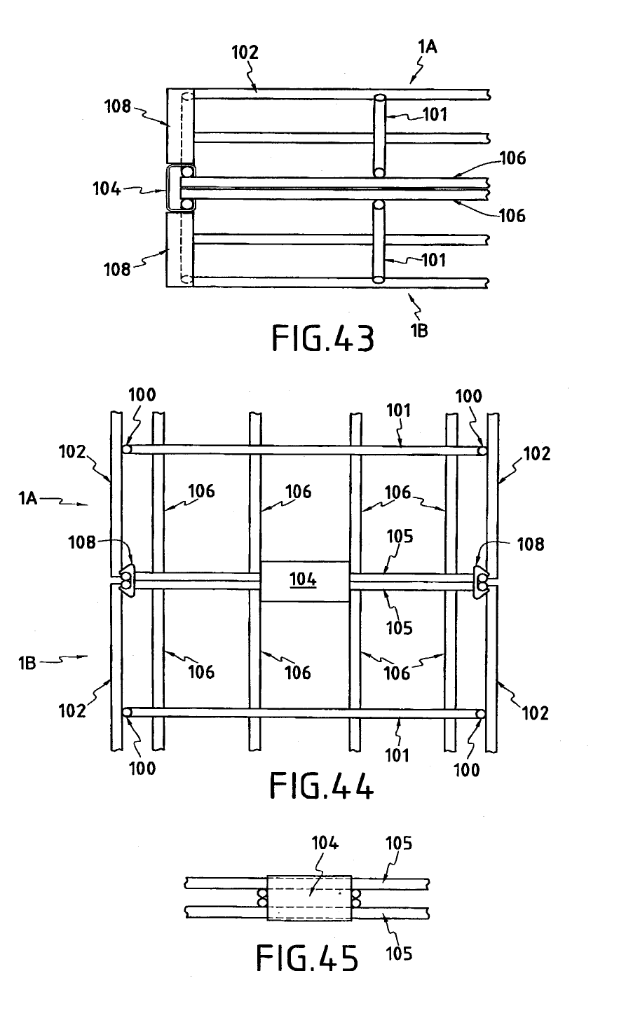

Reference is now made to FIGS. 41 to 62.

As mentioned above, basket type cableways conventionally comprise longitudinally-extending warp wires and transversely-extending weft wires that are located at intervals.

On average, compared with sheet cableways, conventional basket cableways present properties considered as being favorable, such as:

ease of shaping in bends and changes of direction;

ventilation of the cables; and

reduced linear weight (i.e. per meter);

and properties which can be considered as being unfavorable in certain applications:

relatively weaker strength in loading; and

reduced supporting area for the cables.

In order to overcome these drawbacks, it should be observed that the invention also relates to:

cableways in which the flanges are constituted by wire baskets, while the bottom walls are made of expanded metal or of solid or perforated sheet metal; and/or

cableways that are provided with reinforcing lining to support cables, as described below.

The lining comprises at least one plate fixed to the inner or outer face of the basket cableways. In other words, the plate may be fixed on the warp and/or weft wires, with the weft wires being placed on the outer face or on the inner face relative to the layer constituted by the warp wires, or indeed between two layers of warp wires, as is known per se.

In one implementation, the lining comprises at least one plate covering at least a portion of the bottom wall of the cableways, for example by being snap-fastened onto the warp and/or weft wires.

In another embodiment, the lining comprises at least one plate covering at least part of the bottom wall of the cableway and at least part of one or both flanges of the cableway. For this purpose, the lining comprises at least one curved or bent plate, or indeed a plate that has been molded, so as to match the curvature of the weft wires between the flange and the bottom wall of the cableway, said plate being welded, stuck, or snap-fastened to the weft wires and/or to the warp wires.

Snap-fastening is obtained by placing at least one groove and/or flexible tabs in the lining plate, said plate being made of stamped metal or of a section member, or indeed of a thermoformed or molded polymer, or of any other shapeable sheet material, in particular a composite material.

In an embodiment, the basket cableway has, over at least a fraction of its length, lining that substantially covers its bottom wall and both flanges.

In one embodiment, lining plates are provided with bulges that form support surfaces for cables received in the cavity of the cableway, said bulges increasing the stiffness of the cableway.

In an advantageous embodiment, the reinforcing lining has through holes in number and disposition that are adapted, where appropriate, to one or more of the following objectives:

to preserve ventilation for cables placed in the cableway;

to enable clamping collars for the cables to be passed through;

to enable fishplates to be passed through; and

to enable threaded rods, bolts or other fasteners to be passed through for fastening the cableway segments to brackets or to hangers.

By way of example, the lining, reinforcing, and cable support plates may include longitudinally elongate recesses that are buttonhole-shaped and disposed transversely in two or more rows.

In a particular embodiment, the through holes comprise passages obtained by punching out membranes.

The lining as described above serves to mask the cables contained in the wire basket cableway and simultaneously provides increased strength in loading, and also a larger surface area for supporting the cables compared with a bare wire basket, making it easier for cables to slide while they are being laid or during maintenance operations.

Perforations in the reinforcing and cable-supporting lining enable the cables housed in the cableway to continue to be ventilated and enable the relatively low weight per unit length of the cableway to be maintained.

The lining may be provided with identification and signaling means, in particular specifying the function of the cables contained in the cableway. Such identification means include, for example, printing or embossing on at least one of the lining plates, or indeed a special color for one of the lining plates, in particular when said plate is made of a colored polymer or composite.

In order to preserve the ease with which bends and changes of direction can be made using basket cableways, the lining plates are advantageously suitable for folding within their planes and/or away from their planes.

This ability to be folded can be obtained, for example, by disposing lines of perforations or of reduced thickness enabling changes of level to be matched by curving away from the plane of the cableway, with the bottom wall of the cableway then being concave or convex.

The ability of each lining or reinforcing plate to be folded in its own plane, when the bottom wall of the cableway remains substantially plane but changes direction, can be obtained, for example, by placing triangular-shaped cutouts in at least one of the longitudinal edges of the lining plate, the V-shaped edges of these cutouts overlapping when the plate is curved.

Installing lining, reinforcement, and cable-supporting plates as described above makes it possible to obtain cableways that present an excellent compromise between the properties of sheet cableways and those of basket cableways.

Advantageously, the dispositions described with reference to FIGS. 1 to 40 can be applied to lining and reinforcing pieces which are fixed to bare wire basket cableway segments.

Thus, for example:

the two pieces shown in FIG. 1 may be U-shaped plates each fixed to a respective end portion of a basket cableway segment, thus serving not only to join together the basket cableway segments, but also to line them, to identify them, to support their cables, and to provide mechanical reinforcement for the basket cableway segments; and

two lining reinforcing plates of shapes as shown in FIGS. 2, 3, and 10 can be fixed, e.g. snap-fastened to the wire basket flanges of the two basket cableway segments, said lining plates being suitable for being connected together by a joining and locking piece as shown in FIGS. 4 to 9.

In FIGS. 41 to 62, the free edges 100 of the weft wires 101 are chamfered and the flanges of the segments 1A and 1B thus have respective top longitudinal wires referred to as ridge wires 102. This disposition makes it possible to avoid injuring the sheaths of cables during laying, and also to avoid injuring the hands of people laying cables.

Naturally, other measures may also be taken to avoid such risks of injury. Reference can be made in particular to the following documents: FR-2 617 341, FR-2 634 600, FR-2 697 313, EP-0 298 825, EP-0 352 191, DE; 4 336 168, and also to the dispositions described in document EP-1 150 407, by the Applicants.

In the embodiments of FIGS. 41 to 45, a joining loop 103 or joining strip 104 interconnects the end weft wires of the segments 1A and 1B on the bottom wall forming portions 105 of said wires 101.

The warp wires 106 advantageously have chamfered end edges 107 so as to avoid interfering with the pivoting of one segment 1A relative to the other segment 1B. This disposition makes it possible to use a joining loop 103 or a joining strip 104 of small width, the end weft wires of the segments 1A and 1B coming substantially into contact with or being at a small distance apart from each other, as shown in the bottom portion of FIG. 41. It is thus possible to make use of conventional fishplate means for reinforcing the locking of the segments 1A and 1B in longitudinal alignment.

Means for locking in the aligned position are shown in FIGS. 44 to 46, which means comprise two resilient strips 108, with each of the strips 108 clamping together the end weft wires of the segments 1A and 1B that are placed facing each other, each of said strips 108 being placed on a respective one of the two flanges of the segments 1A and 1B.

Locking is thus obtained by snap-fastening due to the strips 108 being elastically deformed.

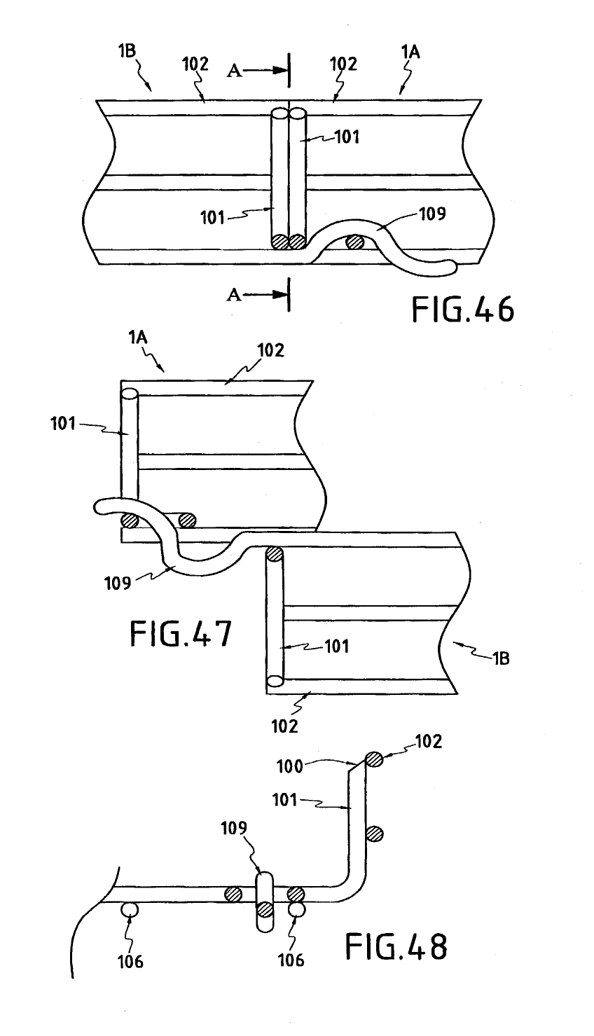

In the embodiment of FIGS. 46 to 48, the pivoting joints between the two segments 1A and 1B enabling them to go from an extreme position in which one is folded on the other (FIG. 47) to an extreme position in which they are in longitudinal alignment (FIG. 46) is provided by an S-shaped longitudinal bend referenced 109 for the projecting end portions of the warp wires of at least one of the segments 1B.

These S-shaped portions of the warp wires project beyond the end transverse weft wire of a first one of the two segments 1B and bear against two successive transverse wires of the second segment, as shown in FIG. 46.

In the thirteenth embodiment shown in FIG. 49, the warp wires 106 are of reduced thickness in at least one zone 110, thus enabling them to be curved from one extreme position in which the two segments 1A and 1B are folded one on the other, to a position in which they are in longitudinal alignment as shown in FIG. 49.

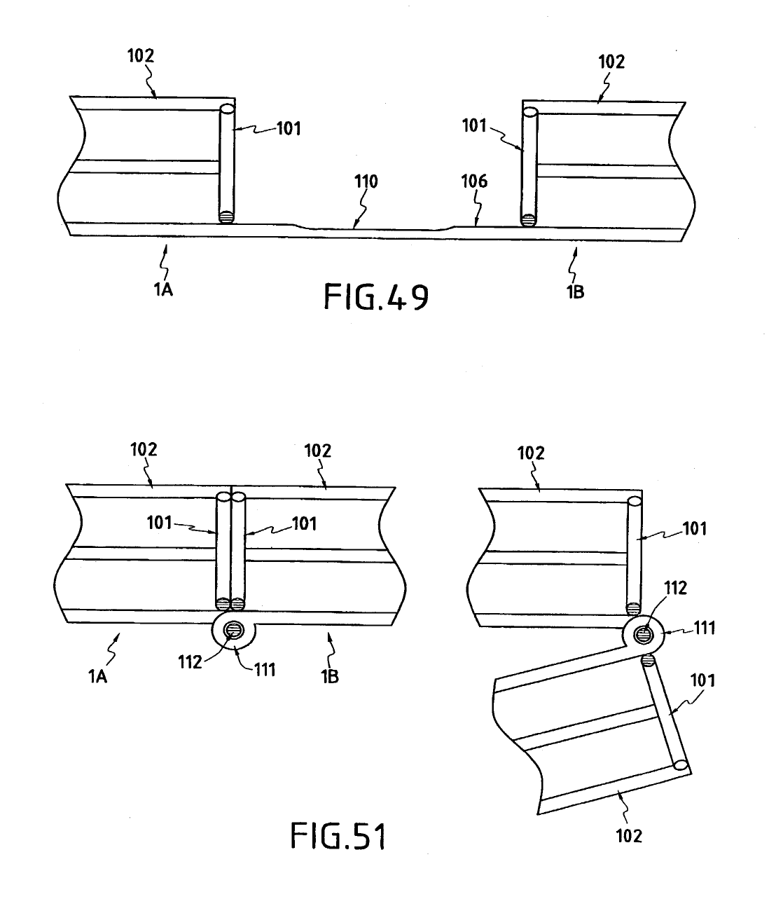

In the embodiment of FIGS. 50 and 51, the warp wires of the bottom walls of the two segments 1A and 1B are provided with loops 111 forming supports for a transverse pin 112.

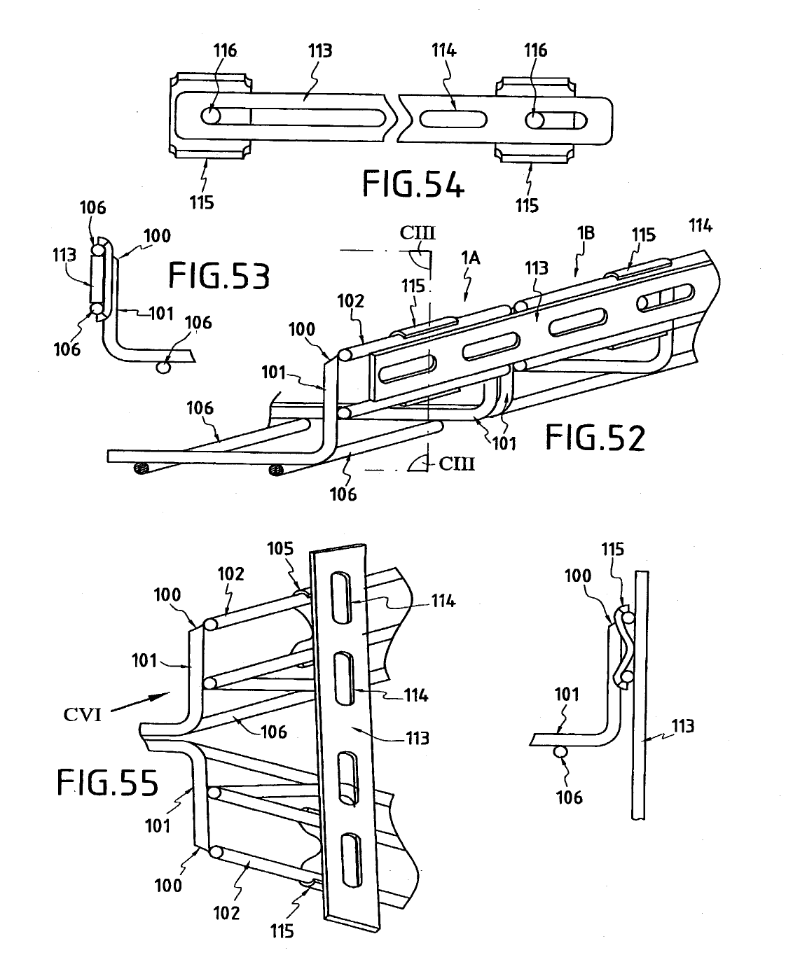

Reference is now made to FIGS. 52 to 56.

A bar 113 provided with oblong through holes 114 forms a link piece between the two segments 1A and 1B. For this purpose, each segment is provided on one of its flanges with a pin support piece 115 of substantially C-shaped cross-section, one of these support pieces 115 being snap-fastened or welded to two warp wires of a flange of each of the two segments 1A and 1B.

The pins 116 carried by these pieces 115 pass through oblong through holes 114 of the bar 113.

In a particular embodiment, the free ends of the pins 116 form flared or bulging round heads, and the pins constitute cores for respective spiral springs (not shown), or any other equivalent resilient means, such as a spring clip, for example.

When the bar 113 is in the longitudinal position shown in FIG. 52, the spring tends to press the bar 113 between the warp wires 106 of the aligned flanges of the segments 1A and 1B, as shown in FIG. 53, thereby locking these two segments in longitudinal alignment. The bar 113 does not project beyond the thickness of the warp wires of the flanges.

When the bar 113 is in a non-longitudinal position, for example as shown in FIG. 55, while one of the segments 1A is pivoting relative to the other, the spring tends to press the bar 113 against the warp wires of the flanges of the segments, as can be seen in FIG. 56.

Reference is now made to FIGS. 57 to 60.

FIGS. 57 to 59 show a first configuration for stacking or slidably folding two basket cableway segments. In this first configuration, a first segment 1A is provided with warp wires 106A and with ridge wires 102A disposed on the inside face relative to the weft wires 101, while the second segment 1B is provided with warp wires 106B and with ridge wires 102B placed on the outer face relative to the weft wires 101.

The second segment 1B presents an outside width that is substantially equal to the inside width of the first segment 1A.

When the second segment 1B is in the storage and transport position, as shown in FIG. 57, the warp wires 106B are disposed between the warp wires 106B of the first segment 1A.

Where appropriate, projections 117 and 118 disposed on the weft wires 101 of the two segments 1A and 1B act in a manner analogous to that described with reference to FIG. 36 to hold the bottom walls of the segments 1A and 1B a determined distance apart.

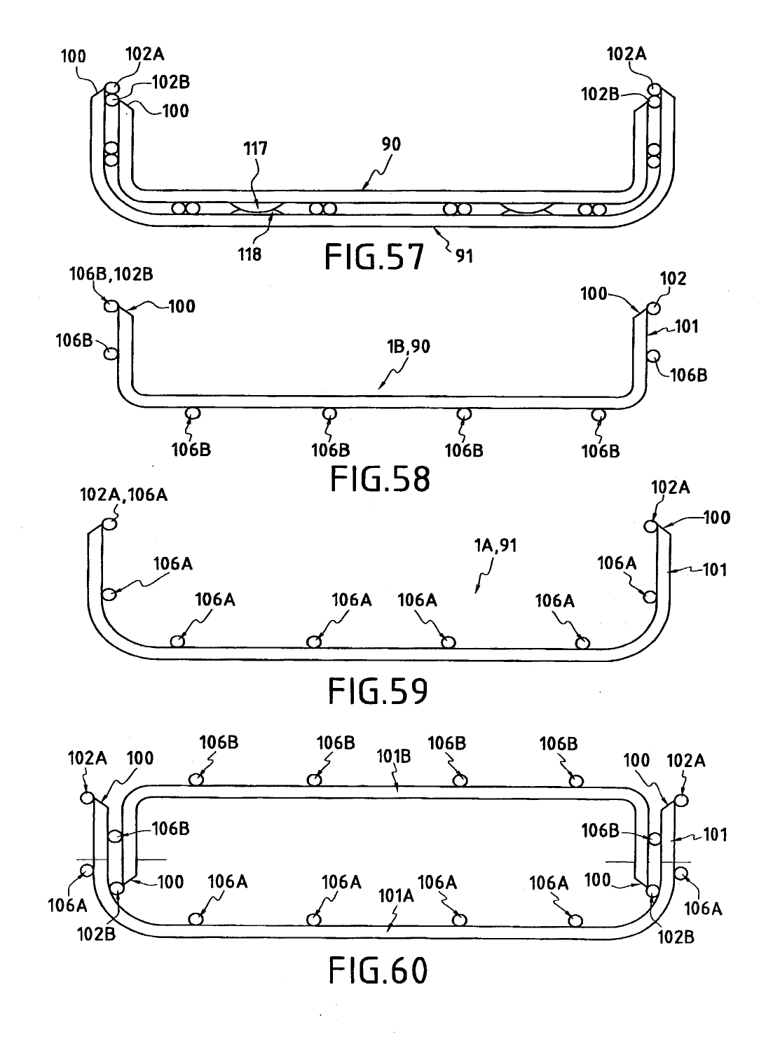

FIG. 60 shows a second configuration for stacking two segments 1A and 1B. In this embodiment, the flanges of a first segment 1A are provided with warp wires and ridge wires 106A, 102A disposed on the outside faces of the weft wires 101A, while the flanges of the second segment 1B are provided with warp wires and ridge wires 106B, 102B that are also disposed on the outside face relative to the weft wires 101B.

When the segments 1A and 1B are in the position where one is folded on the other, the warp wires 106B of the flanges of the second segment 1B bear against the insides of the flanges of the first segment 1A, i.e. against the weft wires 101A of said first segment 1A.

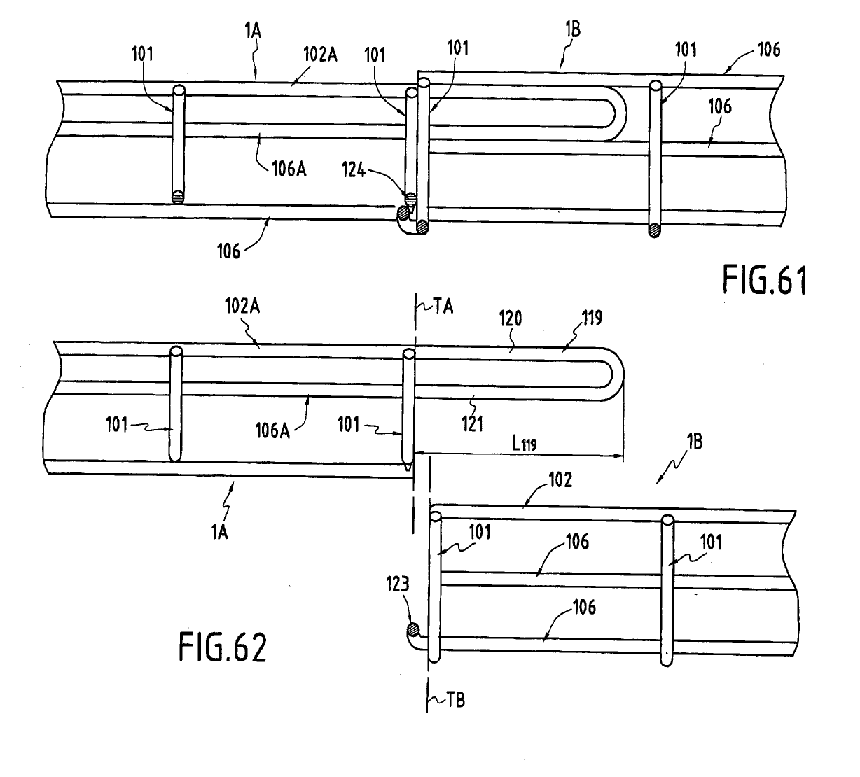

Reference is made below to FIGS. 61 and 62.

In this particular embodiment, two warp wires 106A of a first segment 1A (in this case one of the warp wires of a flange and the ridge wire 102A of said flange) project beyond the end transverse plane TA of said first segment 1A to form a loop 119 comprising two substantially longitudinal portions 120 and 121 and a curved end portion 122 interconnecting said longitudinal portions 120 and 121.

The loop as made in this way is substantially rigid and extends in a plane that lies substantially as an extension to the plane of the flange 3 from which said loop 119 projects.

Ignoring operating clearances, the length L119 of said loop is less than or substantially equal to the distance between two successive weft wires of the second segment 1B, or else to the distance between the end transverse plane TB of the second segment 1B and the first weft wire of said segment 1B (when the second segment does not have a weft wire in the immediate vicinity of said end plane TB).

The second segment 1B is provided with projections 123 on its warp wires, these projections being configured in such a manner as to bear around a weft wire of the first segment (in this case the base portion 124 of the end weft wire of the first segment 1A).

Inserting the loop 119 between the flange warp wires of the second segment 1B serves to lock the two segments 1A and 1B in longitudinal alignment.

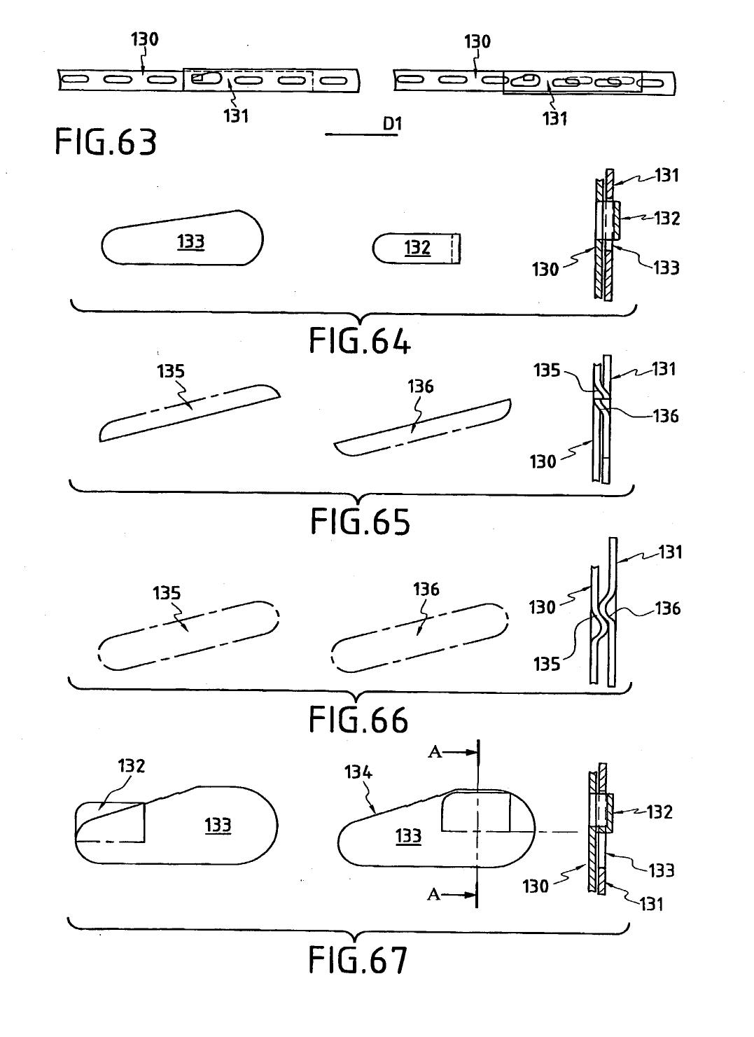

Reference is made below to FIGS. 63 et seq.

When two cableway segments are sliding relative to each other, as described above with reference to FIGS. 37 to 40, or 57 to 59, locking can be obtained in the desired position by the means shown in FIGS. 63 et seq., and also by the means referenced 117, 118 in FIG. 57, the means referenced 124 in FIG. 61, and the means referenced 123 in FIG. 62.

FIG. 63 shows two pieces 130 and 131 in two distinct sliding positions.

These pieces may be the flanges or the bottom walls of two sheet cableways.

In a variant, these pieces may be separate pieces that are fitted subsequently, for example by snap-fastening or welding or any other equivalent means to the flanges or the bottom walls of two basket cableways. These two pieces may thus, in particular, form portions of plates for lining a basket cableway, where such lining and reinforcing plates have the advantages as described above.

One of these two pieces is provided with a projection 132 that is received in an opening 133 in the second piece.

Initially, during sliding, the projection 132 avoids the perforations since it is offset relative to said perforations and occupies a position in the opening 133 substantially without stress due to the elasticity of the sheet metal, this position being shown diagrammatically in the left-hand portions of FIGS. 67 and 64.

Thereafter, following relative sliding of the two pieces 130 and 131, and because of the slope 134 provided in the edge of the opening 133, the projection 132 comes progressively to bear against and be pressed against the edge of said opening, thus preventing additional sliding of one of the pieces relative to the other.

In the variant of FIG. 64 (right-hand portion of this figure), sliding is locked by the complementary shapes of the projection 132 and the edge of the opening 133.

In the variants shown in FIGS. 65 and 66, each of the two pieces 130 and 131 is provided with substantially identical portions in relief 135 and 136 that are offset longitudinally, these portions in relief being inclined relative to direction D1, as is the edge 134 of the opening 133.

What is claimed is:

1/ A cableway, comprising at least two segments provided with means suitable and designed for enabling relative movement of the two segments between a compact, first position for transport or storage and a deployed, second position for use, in which the end portions of the segments are substantially in longitudinal alignment, means being provided to lock the segments in said second position.

2/ A cableway according to claim 1, wherein the means suitable and designed for enabling relative movement of the two segments between their first and second relative positions are articulated joint means or sliding means.

3/ A cableway according to claim 2, wherein the joint means define an axis of articulation substantially parallel to a direction transverse to the bottom walls of the segments.

4/ A cableway according to claim 2, wherein the joint means define an axis of articulation substantially parallel to a direction that is transverse to one of the flanges of each of the segments.

5/ A cableway according to claim 3, wherein the two segments are joined by articulated joint means comprising a hinge.

6/ A cableway according to claim 5, wherein the hinge comprises respective leaves fitted to or integral with each of the two segments, the fitted leaf carrying knuckles complementary to knuckles carried by the other segment.

7/ A cableway acorn to claim 5, wherein the hinge comprises two fitted or integral leaves, each segment supporting one of the leaves, a pin passing through the knuckles of the leaves.

8/ A cableway according to claim 7, wherein the pin is removable.

9/ A cableway according to claim 8, wherein the segments are stackable after removing the pin.

10/ A cableway according to claim 5, wherein the hinge is of the type selected from the group constituted by: hinges having blank leaves for drilling and countersinking from either face, hinges having leaves in the form of sheets folded in half, hinges having leaves that are offset when parallel, hinges with leaves tapering away from their hinge pins, hinges having pairs of parallel pins interconnected by links, spring hinges, piano hinges.

11/ A cableway according to claim 3, wherein each of the two segment carries, on at least one of its transverse edges, knuckle-forming projections formed integrally therewith or fitted thereto.

12/ A cableway according to claim 11, wherein a first segment carries, on one of its transverse free edges, at least two knuckle-forming projections, a second segment for being joined to the first segment carrying on one of its transverse free edges at least two through holes for passing said projections.

13/ A cableway according to claim 12, wherein the through holes in the bottom wall of the second segment are set back longitudinally from the transverse plane tangential to the free end edges of the flanges of said second segment.

14/ A cableway according to claim 12, wherein the knuckle-forming projections disposed on the bottom wall of the first segment project beyond the transverse plane tangential to the free end edges of the flanges of said first segment.

15/ A cableway according to claim 1, wherein each of the two segments comprises two flanges projecting from the side edges of a bottom wall, the articulated joints between the two segments enabling them to move between their first and second relative positions being provided by joint means placed on each of the flanges of said segments.

16/ A cableway according to claim 15, wherein the joint means comprise link pieces mounted or shaped on the facing inner faces of the flanges of the segments.

17/ A cableway according to claim 16, wherein each link piece presents at least one slot through which there passes a pin carried by a flange of a first segment, each link piece further comprising at least one stud that engages in a recess carried by a flange of the second segment, the engagement of the stud in the recess during pivoting of one segment relative to the other serving to lock the end portions of the two segments in longitudinal alignment.

18/ A cableway according to claim 16, wherein the link pieces are substantially plane and in the form of half-disks or half-rings.

19/ A cableway according to claim 16, wherein the end portions of the segments that face each other are provided with longitudinal slots for passing link pieces.

20/ A cableway according to claim 16, wherein the top longitudinal edges of the flanges of the segments are folded over towards the insides of the segments.

21/ A cableway according to claim 17, wherein the studs of the link pieces are the result of stamping, the recesses in which said studs are received being through holes.

22/ A cableway according to claim 15, wherein the joint means comprise two link pieces mounted on the outer faces of the flanges of the segments.

23/ A cableway according to claim 22, wherein each link piece includes an elongate slot in which two pins projecting outwards from the segment flanges are slidably received, said slot being provided with notches that are spaced apart by substantially the distance between the pins as measured when the two segments are in the longitudinally-aligned position.

24/ A cableway according to claim 1, wherein the two segments are joined by means of a transverse line of weakness.

25/ A cableway according to claim 24, wherein the line of weakness comprises perforations through the bottom walls or one of the flanges of the segments, and/or reduced thickness in said bottom walls or said flanges.

26/ A cableway according to claim 1, wherein the flanges of a first segment are provided with longitudinal projections supporting a transverse pin common to the flanges of the second segment.

27/ A cableway according to claim 26, wherein at least one of the longitudinal projections is provided with portions in relief such as stampings that are received in locking setbacks disposed in the second segment, when the two segment are in longitudinal alignment.

28/ A cableway according to claim 26, wherein the flanges of the first and second segments are substantially parallel to the bottom walls of the segments, the free edges of the flanges being folded over towards the insides of the segments.

29/ A cableway according to claim 1, wherein the two segments are joined by joint means comprising a spring blade.

30/ A cableway according to claim 29, wherein the spring blade is fixed by adhesive, welding, or snap-fastening to the bottom wall or to one of the flanges of the two hinged segments.

31/ A cableway according to claim 1, wherein at least one of its segments is provided with projections on the bottom face of its bottom wall, said projections forming support abutments when the segments are stacked, engaging the inside face of the segment placed beneath it in the stack.

32/ A cableway according to claim 1, comprising at least one inner, first segment mounted to slide relative to an outer, second segment, the inner segment and the outer segment being substantially geometrically similar, locking means serving to lock the two segments relative to each other at the end of their stroke.

33/ A cableway according to claim 32, wherein the top longitudinal edges of the flanges of each of the outer and inner segments are folded over towards the outside or towards the inside of the segments.

34/ A cableway according to claim 32, wherein the flanges of the inner and outer segments are provided with respective steps preventing the inner segment moving vertically relative to the outer segment.

35/ A cableway according to claim 1, wherein at least one of the two segments is based on a bare or lined wire basket structure, or on an optionally perforated sheet.

36/ A cableway according to claim 1, wherein the end portions of the two segments are made as wire baskets, the joint means comprising a joint loop or strip connecting together the end weft wires of the segments via their base portions constituting the bottom walls of said segments.

37/ A cableway according to claim 1, wherein the end portions of the two segments are made as wire baskets, the joint means comprising at least two projecting end portions of the warp wires of at least one of the segments, said end portions being curved into S-shapes.

38/ A cableway according to claim 1, wherein the end portions of the two segments are made as wire baskets, the joint means comprising a portion of reduced thickness of the warp wires in at least one zone of the bottom walls or one of the flanges of said segments.

39/ A cableway according to claim 36, wherein the means for locking the end portions of the segments in the longitudinally-aligned position comprise a bar held pressed between the warp wires of contiguous flanges of the two segments, said bar being mounted in articulated manner to both of the segments.

40/ A cableway according to claim 36, wherein a resilient strip on at least one of the flanges of the segments clamps together the end weft wires of the segments placed facing each other, when the end portions of the segments are in their longitudinally-aligned position.
